(19) United States
(12) Patent Application Publication
(10) Pub. No.: US 2004/0110899 A1
(43) Pub. Date: Jun. 10, 2004

(54) Resin composition extruded article and anti-static sheet

(76) Inventors: Naoya Miara, Nagahama-shi (JP); Nobuyasu Suzuki, Nagahama-shi (JP); Masahiko Kawano, Nagahama-shi (JP)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/398,353

(22) PCT Filed: Oct. 4, 2001
(86) PCT No.: PCT/JP01/08768

(30) Foreign Application Priority Data
Oct. 4, 2000 (JP) 2000-304992
Mar. 5, 2001 (JP) 2001-60574
Apr. 10, 2001 (JP) 2001-111779
Sep. 11, 2001 (JP) 2001-274466
Sep. 19, 2001 (JP) 2001-285096
Sep. 19, 2001 (JP) 2001-285097
Sep. 21, 2001 (JP) 2001-288566
Sep. 26, 2001 (JP) 2001-292929

(51) Int. Cl. C08L 65/00; C08L 67/00

(52) U.S. Cl. 525/63; 525/165

(57) ABSTRACT

A resin composition has 60 to 85% by weight of a polystyrene resin, and 15 to 40% by weight of a polyether ester amide. The polystyrene resin is a copolymer comprising a styrene monomer and a (meth)acrylate monomer.

### TECHNICAL FIELD

The present invention relates to a resin composition from which an extruded article having excellent anti-static properties can be obtained by extrusion, an extruded article produced from the resin composition, and an anti-static sheet, having excellent vacuum formability and excellent anti-static properties. More particularly, the present invention is concerned with an extruded article and an anti-static sheet each forming a container used for storage, transfer, and molding of electronic materials, such as integrated circuits (ICs), large scale integrated-circuits (LSIs), silicon wafers, hard disks, liquid crystal substrates, and electronic parts, so that these electronic parts are prevented from suffering damage and contamination due to static electricity, and a resin composition used as a raw material for the above extruded article and anti-static sheet.

### BACKGROUND ART

In recent years, there are increasing demands for small-size electronic parts, especially for chip-type electronic parts, such as ICs and diodes. Most of the carrier trays for electronic parts are formed by vacuum forming or heat press molding which requires no large plant investment.

Places at which parts constituting personal computers and hard disks are produced and places at which the parts are assembled are separately present. For this reason, the parts tend to be downsized and there are increasing occasions where the parts are stored, transferred, or mounted to containers.

Extruded articles and extruded sheets of polystyrene, polyethylene terephthalate, or polyvinyl chloride generally have a high volume resistivity and a high surface resistivity, and therefore are suitable for use in insulating materials. However, such an extruded sheet is easily charged by friction or touch, due to the high surface resistivity. When the extruded sheet is used in a packaging container for an electronic circuit board having IC products, static electricity which clings on the container cases damages parts contained therein. In addition, when a container used for storage of electronic parts, such as a tray or a carrier tape, is electrostatically charged, it is difficult to securely mount the parts to the container.

For solving these problems, anti-static properties are imparted to an extruded sheet. As methods for imparting anti-static properties, there are employed a method in which carbon black or a low molecular-weight surfactant is incorporated into the extruded sheet, a method in which a surfactant is applied to the surface of the extruded sheet, and a method in which an anti-static agent is applied to the extruded sheet.

Japanese Unexamined Patent Publication Nos. Sho 57-205145 and Sho 59-83644 disclose a sheet comprising a polystyrene sheet base material or acrylonitrile-butadiene-styrene (ABS) resin sheet base material having on the surface thereof carbon black as a conductive layer. By incorporating carbon black into the resin, the surface resistivity and volume resistivity of the resultant extruded article or extruded sheet can be easily adjusted to be predetermined values. However, the method in which carbon black is incorporated into the resin has the following disadvantages.

(1) The portion elongated in shaping changes in resistivity and thus exhibits no antistat effect.

(2) The fabricability (elongation) of the resultant extruded article and extruded sheet becomes poor.

(3) The resultant extruded article and extruded sheet are completely opaque, so that it is difficult to confirm the electronic parts contained in a container formed from the article or sheet. Further, positioning of the container using an optical sensor or the like is difficult.

(4) During cutting of the extruded sheet, carbon black is removed from the cross-section of the extruded sheet.

(5) During use of the extruded sheet, carbon black is removed from the surface of the sheet by friction. Therefore, there is a danger that the insulation between the IC terminals disposed on the sheet is deteriorated.

In the method in which a low molecular-weight surfactant is incorporated into or applied to the sheet, the transparency and the initial antistat effect of the sheet can be secured. However, this method also has the following disadvantages.

(1) The method is largely affected by humidity.

(2) The surfactant flows away by washing with water.

(3) The smoothness of surfaces of the resultant extruded article and extruded sheet becomes poor, thus causing shaping failure.

As another method, there is a method in which an electrically conductive coating is applied to the surface of the extruded sheet. However, it is important for this method that the adhesion between the coating and a resin constituting the base material be good. For this reason, the usable base materials are limited.

For overcoming the above-mentioned disadvantages, Japanese Unexamined Patent Publication No. Hei 9-14323 proposes a method in which an injection-molded container is produced using a permanent anti-static resin composition containing 15 parts by weight or less of a polyether ester amide. In this method, the polyether ester amide receives a large shear force from the sidewall of a mold during cooling, so that the polyether ester amide is dispersed in a stripe form. Thus, the surface resistivity of the injection-molded container is lowered, exhibiting an antistat effect.

However, in the above patent publication document, the method is not intended to be applied to extrusion. In the extrusion, a large shear force is not exerted on the composition, and hence, a satisfactory antistat effect cannot be obtained by charging the above-mentioned amount of the polyether ester amide. For obtaining a satisfactory antistat effect, the amount of the polyether ester amide charged needs to be increased, but such an increase of the polyether ester amide causes not only the strength of the extruded sheet to be lowered but also the cost to increase.

There are many types of electronic parts, and, for preventing the plant investment for electronic parts from increasing, vacuum forming or heat press molding is almost always employed as a method for producing carrier trays for electronic parts. In the market, an anti-static sheet having excellent permanent anti-static properties, molding properties and transparency is required. For meeting the requirement for permanent anti-static properties, it is necessary that the volume resistivity of the sheet be 10¹² Ω·cm or less. However, when a polyether ester amide is dispersed in a thermoplastic resin so that the volume resistivity of the resultant sheet becomes 10¹² Ω·cm or less, the weight ratio of the polyether ester amide to the sheet becomes high, so that the physical properties of the polyether ester amide largely affect the sheet to lower the strength of the sheet itself. Therefore, a tray which is not suitable as a carrier tray is formed.

As shown in FIG. 4, an anti-static co-extruded sheet comprising a core layer 22 comprised of a polystyrene resin or ABS resin having on both surfaces thereof outer layers 23 comprised of a polystyrene resin or ABS resin containing therein carbon black (Japanese Patent No. 2930872) has been put into practical use. Further, Japanese Unexamined PCT Patent International Publication (kohyo) No. 2000-507891 proposes a technique in which only the surface resistivity of a tray is adjusted to be 10¹⁰ Ω or less to secure the properties of the tray.

Further, a method in which a polyether ester amide is incorporated into a polyester resin to adjust the surface resistivity is known. However, the difference in refractive index between the polyester resin and the polyether ester amide is 0.03 or more, and therefore a transparent sheet cannot be obtained and the electronic parts contained in a container formed from the resultant sheet cannot be confirmed from the outside of the container.

When a polyether ester amide is incorporated into a polystyrene resin, the polyether ester amide is dispersed in the polystyrene resin in a stripe form. Therefore, the hydro shot impact value of the sheet formed is low, so that a container formed using this sheet by vacuum forming is easily broken.

The volatile component of the resin constituting a container may cause electronic parts contained in the container to suffer contamination. For example, when contaminant adheres to the surface of a hard disk head or an optical lens member, a pick-up failure occurs.

It is desired that static electricity is dissipated not only from the surface of the sheet along the surface but also in the thicknesswise direction of the sheet.

### DISCLOSURE OF THE INVENTION

It is a first object of the present invention to provide a resin composition for extrusion from which an extruded article having excellent anti-static properties and excellent molding properties and durability can be easily obtained.

It is a second object of the present invention to provide a resin composition from which an extruded article having good transparency can be obtained.

It is a third object of the present invention to provide an anti-static sheet which is advantageous in that it has excellent anti-static properties, molding properties, durability and transparency, as well as it does not cause contamination due to any volatile component.

For attaining the above objects, the present invention provides an anti-static sheet comprising 60 to 85% by weight of a polystyrene resin and 15 to 40% by weight of a polyether ester amide. The polystyrene resin is a copolymer comprising a styrene monomer and a (meth)acrylate monomer.

An anti-static sheet of another embodiment of the present invention comprises 60 to 85% by weight of a polystyrene resin and 15 to 40% by weight of a polyether ester amide. The polystyrene resin is a copolymer comprising a styrene monomer and a (meth)acrylate monomer, which has a rubber-like elastomer dispersed therein.

The present invention further provides a resin composition comprising a polystyrene resin which includes a copolymer containing a styrene monomer and a (meth)acrylate monomer. The resin composition comprises 60 to 85% by weight of the polystyrene resin and 15 to 40% by weight of a polyether ester amide, and has a melt viscosity of 2×10³ to 8×10⁴ (poises) at a shear rate of 10 (sec⁻¹) at 200° C.

A resin composition of another embodiment of the present invention comprises a polystyrene resin obtained by dispersing a rubber-like elastomer in a continuous phase of a copolymer comprising a styrene monomer and a (meth)acrylate monomer. The resin composition comprises 60 to 85% by weight of the polystyrene resin and 15 to 40% by weight of a polyether ester amide, and has a melt viscosity of 2×10³ to 8×10⁴ (poises) at a shear rate of 10 (sec⁻¹) at 200° C.

An anti-static sheet of still another embodiment of the present invention comprises a core layer, formed by dispersing a polyether ester amide in a thermoplastic resin, having an elastic modulus in tension of 900 MPa or more at ordinary temperature and having a volume resistivity of 10¹² Ω·cm or less. An outer layer is formed on the surface of the core layer. The outer layer is formed from a material comprising a thermoplastic resin having dispersed therein a polyether ester amide so that the surface resistivity of the outer layer becomes 10¹⁰ Ω or less.

An anti-static sheet of still another embodiment of the present invention comprises a sheet base material comprising a polystyrene or ABS resin. A layer is formed on at least one surface of the sheet base material. The layer comprises 15 to 75 parts by mass of a polyether ester amide relative to 100 parts by mass of a polystyrene resin, wherein the difference in refractive index between the polystyrene resin and the polyether ester amide is less than 0.03. The layer has a surface resistivity of 10⁹ to 10¹² Ω.

An anti-static sheet of still another embodiment of the present invention comprises 15 to 75 parts by mass of a polyether ester amide relative to 100 parts by mass of a polystyrene resin, wherein the difference in refractive index between the polystyrene resin and the polyether ester amide is less than 0.03. After the anti-static sheet is subjected to heat treatment at 85° C. for 60 minutes, the volatile component of the sheet is 100 ppm or less.

An anti-static sheet of still another embodiment of the present invention comprises 15 to 75 parts by mass of a polyether ester amide relative to 100 parts by mass of a polystyrene resin, wherein the difference in refractive index between the polystyrene resin and the polyether ester amide is less than 0.03, and 1 to 10 parts by mass of a graft polymer comprising epoxy-modified acryl, polystyrene, and polymethyl methacrylate (PMMA).

### BRIEF DESCRIPTION OF THE DRAWINGS

FIG. 1 is a partially cross-sectional view of an anti-static sheet according to one embodiment.

FIG. 2 is a cross-sectional view of an anti-static sheet according to another embodiment.

FIG. 3(A) is a diagrammatic cross-sectional view of a feed block in another embodiment.

FIG. 3(B) is a partial view of the feed block of FIG. 3(A) as viewed from the direction B.

FIG. 4 is a cross-sectional view of a conventional anti-static sheet.

### BEST MODE FOR CARRYING OUT THE INVENTION

Hereinbelow, the first embodiment of the present invention will be described.

The resin composition for extrusion comprises a polystyrene resin, and the polystyrene resin is obtained by dispersing a rubber-like elastomer in a continuous phase of a copolymer comprising a styrene monomer and a (meth)acrylate monomer. The resin composition is comprised mainly of 60 to 85% by weight of the polystyrene resin and 15 to 40% by weight of a polyether ester amide. In the continuous phase, the styrene monomer comprises a constituent unit represented by the formula (I), and the (meth)acrylate monomer comprises a constituent unit represented by the formula (II).

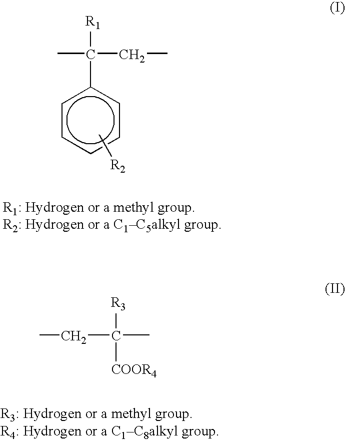

As the styrene monomer, styrene, α-methylstyrene, or p-methylstyrene is used. As the (meth)acrylate monomer, methyl (meth)acrylate, butyl (meth)acrylate, 2-ethylhexyl (meth)acrylate, lauryl (meth)acrylate, or stearyl (meth)acrylate is used. The above “(meth)acrylate” means acrylate or methacylate.

The styrene monomer to (meth)acrylate monomer ratio is selected so that the refractive index of the continuous phase comprised of these monomers is close to the refractive index of the selected rubber-like elastomer particles dispersed. Generally, the styrene monomer to (meth)acrylate monomer ratio is appropriately adjusted in the range of from 30 to 90:70 to 10% by weight when taking other properties such as melt viscosity of the resultant resin composition into consideration.

In the present invention, the styrene monomer employed most preferably is styrene, and most preferred (meth)acrylate monomers are methyl methacrylate (MMA) and butyl acrylate (BA). These monomers are industrially produced in extremely large scale, thus making it possible to suppress the cost and conduct copolymerization with high reactivity.

The copolymerization ratio is adjusted in the range of from 30 to 90:7 to 67:3 to 25% by weight, in terms of styrene/MMA/BA ratio. The amount of MMA is preferably in the range of from 20 to 60% by weight. When the copolymerization ratio falls outside of the above range, it is difficult to adjust the refractive index of the continuous phase so as to be close to the refractive index of the elastomer particles dispersed, thus lowering the transparency of the resin composition.

A rubber-like elastomer is contained as particles dispersed in the continuous phase comprising the styrene copolymer. Any rubber-like elastomer can be used as long as it exhibits rubber properties at room temperature. As the rubber-like elastomer, for example, a polybutadiene, a styrene-butadiene copolymer, a styrene-butadiene block copolymer, or an isoprene copolymer can be preferably used.

The content of the rubber-like elastomer in the composition is 1 to 20% by weight, more preferably 3 to 15% by weight. When the rubber-like elastomer content is less than 1% by weight, the impact resistance of the resultant extruded article is lowered. On the other hand, when the elastomer content exceeds 20% by weight, the stiffness of the resultant extruded article is lowered, causing a problem about the stiffness as a structure. Further, when the elastomer content exceeds 20% by weight, the melt viscosity of the composition increases to deteriorate the molding properties of the composition.

It is preferred that the dispersed particles of the rubber-like elastomer have a particle diameter of 0.1 to 1.5 μm. When the particle diameter is smaller than 0.1 μm, the impact resistance of the resultant extruded article is lowered. On the other hand, when the particle diameter exceeds 1.5 μm, the haze of the resultant extruded article becomes poor to lower the transparency of the extruded article.

The resin composition for extrusion of the present invention need not be a polystyrene resin obtained by dispersing a rubber-like elastomer in a copolymer comprising a styrene monomer and a (meth)acrylate monomer. The polystyrene resin may be constituted by, for example, a copolymer comprising a styrene monomer and a (meth)acrylate monomer.

In the present embodiment, a polystyrene resin obtained by dispersing a rubber-like elastomer in a continuous phase of a copolymer comprising a styrene monomer and a (meth)acrylate monomer is referred to as dispersed polystyrene resin, and a polystyrene resin having no rubber-like elastomer dispersed therein is referred to as non-dispersed polystyrene resin.

The polyether ester amide used in the production of the anti-static sheet of the present invention generally comprises the following three constituent units.

(1) An aminocarboxylic acid or lactam having 6 or more carbon atoms, or a salt of a diamine having 6 or more carbon atoms and a dicarboxylic acid is used.

Examples of aminocarboxylic acids include ω-aminoenanthic acid and ω-aminocaproic acid. Examples of lactams include caprolactam and enanthlactam. As the salt of a diamine and a dicarboxylic acid, a hexamethylenediamine-adipic acid salt is used.

(2) Polyether

Examples include polyethylene glycol and poly(tetramethylene oxide) glycol.

(3) Dicarboxylic Acid

A dicarboxylic acid having 4 to 20 carbon atoms, such as terephthalic acid, is used.

Further, in the present invention, when considering also transparency of the resin composition or extruded article as an important factor, the constituents are selected so that the difference in refractive index between the dispersed polystyrene resin and the polyether ester amide becomes 0.03 or less. When the difference in refractive index exceeds 0.03, satisfactory transparency cannot be obtained. The refractive index can be adjusted by changing the proportions of the above-mentioned three constituents of the polyether ester amide.

An extruded article having predetermined anti-static properties and molding properties can be obtained by mixing, into a continuous phase of a copolymer comprising a styrene monomer and a (meth)acrylate monomer, 60 to 85% by weight of a dispersed polystyrene resin and 15 to 40% by weight of a polyether ester amide, and subjecting the resultant mixture to general extrusion.

When the amount of the polyether ester amide is less than 15% by weight, the anti-static properties of the resultant extruded article are not satisfactory. On the other hand, when the amount of the polyether ester amide exceeds 40% by weight, the stiffness of the resultant extruded article is lowered, so that not only can excellent physical properties of the extruded article not be kept, but also the molding properties of the composition becomes poor. Further, at high levels of polyether ester amide the cost for the resin composition is increased, so that the range of application of the extruded article is narrowed.

In the extrusion, for achieving excellent extrusion property, it is necessary that the resin composition have a melt viscosity of 2×10³ to 8×10⁴ (poises) at a shear rate of 10 (sec⁻¹) at 200° C. The resin composition having a low melt viscosity is not suitable especially for contour extrusion because the strength of the composition being molten is low. On the other hand, the resin composition having a high melt viscosity is not suitable for mass production because flowability failure occurs and a high torque is exerted in a head especially in sheet forming.

The above melt viscosity can be obtained by selecting the type and amount of the rubber-like elastomer used and adjusting the copolymerization ratio between the styrene monomer and the (meth)acrylate monomer in the dispersed polystyrene resin.

The melt viscosity may be adjusted by combining a lubricant and a processing aid used in general plastics as a third component. When a non-dispersed polystyrene resin is used, the melt viscosity is adjusted by this method. Alternatively, the melt viscosity can be adjusted by changing the molecular weight of the polystyrene resin.

In the extrusion, pellets comprising two components are kneaded by means of a co-rotating twin-screw extruder and extruded through a T-die, followed by shaping into shaped articles by casting or polishing. A representative extruded article is a sheet material, but may be a tubular material, a plate material, or a profile shape article.

In the resin composition for extrusion of the present invention, if desired, a stabilizer, a plasticizer, and a coloring agent can be added.

Hereinbelow, the present embodiment will be described in more detail with reference to the following Examples and Comparative Examples.

### EXAMPLE 1

70% by weight of a dispersed polystyrene resin (trade name: CLEAPACT TI350; Dainippon Ink & Chemicals Incorporated) and 30% by weight of a polyether ester amide (trade name: PELESTAT NC7530; Sanyo Chemical Industries, Ltd.) were mixed together in a pellet form. The resultant mixture was kneaded by means of a co-rotating twin-screw extruder and extruded through a T-die, followed by polishing to obtain a plate having a thickness of 1 mm.

### EXAMPLE 2

Shaping was conducted in the same manner as in Example 1 except that PELESTAT NC6321 (trade name; Sanyo Chemical Industries, Ltd.) was used as a polyether ester amide to obtain a plate having a thickness of 1 mm. When PELESTAT NC6321 is used, the difference in refractive index between the dispersed polystyrene resin and the polyether ester amide exceeds 0.03.

### EXAMPLE 3

85% by weight of a dispersed polystyrene resin (trade name: CLEAPACT TI350; Dainippon Ink & Chemicals Incorporated) and 15% by weight of a polyether ester amide (trade name: PELESTAT NC7530; Sanyo Chemical Industries, Ltd.) were mixed together in a pellet form, and then shaping was conducted in the same manner as in Example 1 to obtain a plate having a thickness of 1 mm.

### EXAMPLE 4

60% by weight of a dispersed polystyrene resin (trade name: CLEAPACT TI350; Dainippon Ink & Chemicals Incorporated) and 40% by weight of a polyether ester amide (trade name: PELESTAT NC7530; Sanyo Chemical Industries, Ltd.) were mixed together in a pellet form, and then shaping was conducted in the same manner as in Example 1 to obtain a plate having a thickness of 1 mm.

### EXAMPLE 5

70% by weight of a non-dispersed polystyrene resin, 30% by weight of a polyether ester amide (trade name: PELESTAT NC7530; Sanyo Chemical Industries, Ltd.), and a lubricant and a processing aid (Hi-wax 1160H; Mitsui Chemicals Co., Ltd.) [in an amount of 3% by weight, based on the total weight (100% by weight) of the above polymers] were mixed together, and then shaping was conducted in the same manner as in Example 1 to obtain a plate having a thickness of 1 mm.

### EXAMPLE 6

Shaping was conducted in the same manner as in Example 5 except that PELESTAT NC6321 (trade name; Sanyo Chemical Industries, Ltd.) was used as a polyether ester amide to obtain a plate having a thickness of 1 mm. When PELESTAT NC6321 is used, the difference in refractive index between the dispersed polystyrene resin and the polyether ester amide exceeds 0.03.

### EXAMPLE 7

85% by weight of a non-dispersed polystyrene resin, 15% by weight of a polyether ester amide (trade name: PELESTAT NC7530; Sanyo Chemical Industries, Ltd.), and a lubricant and a processing aid (Hi-wax 1160H; Mitsui Chemicals Co., Ltd.) [in an amount of 3% by weight, based on the total weight (100% by weight) of the above polymers] were mixed together, and then shaping was conducted in the same manner as in Example 1 to obtain a plate having a thickness of 1 mm.

### EXAMPLE 8

60% by weight of a non-dispersed polystyrene resin, 40% by weight of a polyether ester amide (trade name: PELESTAT NC7530; Sanyo Chemical Industries, Ltd.), and a lubricant and a processing aid (Hi-wax 1160H; Mitsui Chemicals Co., Ltd.) [in an amount of 3% by weight, based on the total weight (100% by weight) of the above polymers] were mixed together, and then shaping was conducted in the same manner as in Example 1 to obtain a plate having a thickness of 1 mm.

### COMPARATIVE EXAMPLE 1

90% by weight of a dispersed polystyrene resin (trade name: CLEAPACT TI350; Dainippon Ink & Chemicals Incorporated) and 10% by weight of a polyether ester amide (trade name: PELESTAT NC7530; Sanyo Chemical Industries, Ltd.) were mixed together in a pellet form, and then shaping was conducted in the same manner as in Example 1 to obtain a plate having a thickness of 1 mm.

### COMPARATIVE EXAMPLE 2

55% by weight of a dispersed polystyrene resin (trade name: CLEAPACT TI350; Dainippon Ink & Chemicals Incorporated) and 45% by weight of a polyether ester amide (trade name: PELESTAT NC7530; Sanyo Chemical Industries, Ltd.) were mixed together in a pellet form, and then shaping was conducted in the same manner as in Example 1 to obtain a plate having a thickness of 1 mm.

### COMPARATIVE EXAMPLE 3

70% by weight of a dispersed polystyrene resin (trade name: DENKA TX POLYMER TX-400-300L; Denki Kagaku Kogyo Kabushiki Kaisha) and 30% by weight of a polyether ester amide (trade name: PELESTAT NC7530; Sanyo Chemical Industries, Ltd.) were mixed together in a pellet form, and then shaping was conducted in the same manner as in Example 1 to obtain a plate having a thickness of 1 mm.

### COMPARATIVE EXAMPLE 4

70% by weight of a dispersed polystyrene resin (trade name: Cevian-MAS MAS30; Dicel Chemical Industries, Ltd.) and 30% by weight of a polyether ester amide (trade name: PELESTAT NC7530; Sanyo Chemical Industries, Ltd.) were mixed together in a pellet form, and then shaping was conducted in the same manner as in Example 1 to obtain a plate having a thickness of 1 mm.

### COMPARATIVE EXAMPLE 5

90% by weight of a non-dispersed polystyrene resin, 10% by weight of a polyether ester amide (trade name: PELESTAT NC7530; Sanyo Chemical Industries, Ltd.), and a lubricant and a processing aid (Hi-wax 1160H; Mitsui Chemicals Co., Ltd.) [in an amount of 3% by weight, based on the total weight (100% by weight) of the above polymers] were mixed together, and then shaping was conducted in the same manner as in Example 1 to obtain a plate having a thickness of 1 mm.

### COMPARATIVE EXAMPLE 6

55% by weight of a non-dispersed polystyrene resin, 45% by weight of a polyether ester amide (trade name: PELESTAT NC7530; Sanyo Chemical Industries, Ltd.), and a lubricant and a processing aid (Hi-wax 1160H; Mitsui Chemicals Co., Ltd.) [in an amount of 3% by weight, based on the total weight (100% by weight) of the above polymers] were mixed together, and then shaping was conducted in the same manner as in Example 1 to obtain a plate having a thickness of 1 mm.

### COMPARATIVE EXAMPLE 7

70% by weight of a non-dispersed polystyrene resin, 30% by weight of a polyether ester amide (trade name: PELESTAT NC7530; Sanyo Chemical Industries, Ltd.), and a lubricant and a processing aid (stearic acid) [in an amount of 5% by weight, based on the total weight (100% by weight) of the above polymers] were mixed together, and then shaping was conducted in the same manner as in Example 1 to obtain a plate having a thickness of 1 mm.

Using the above-obtained specimens, the measurement tests and evaluations described below were conducted. The results are shown in Tables 1 to 4. The dispersed polystyrene resin used in each of the above Examples and Comparative Examples is a styrene/MMA/BA terpolymer.

(Elastic Modulus in Tension)

With respect to each of the specimens, elastic modulus in tension was measured in accordance with JIS K 7112.

The criteria for the evaluation of the elastic modulus in tension are as follows. Rating ◯ indicates that a specimen has a predetermined stiffness such that the elastic modulus in tension is 900 MPa or more at ordinary temperature, and rating χ indicates that a specimen has elastic modulus in tension of less than 900 MPa at ordinary temperature.

(Surface Resistivity and Volume Resistivity)

With respect to each of the specimens, surface resistivity and volume resistivity were measured in accordance with JIS K 6911.

The criteria for the evaluation of the surface resistivity and volume resistivity are as follows. Rating ◯ indicates that a specimen has a remarkable antistat effect free of a problem about the anti-static properties such that each of the surface resistivity (Ω) and the volume resistivity (Ω·cm) is less than 10¹², rating Δ indicates that a specimen has only a small antistat effect such that each of the surface resistivity (Ω) and the volume resistivity (Ω·cm) is 10¹² to 10¹³, and rating χ indicates that a specimen has no antistat effect and has a problem about the anti-static properties such that each of the surface resistivity (Ω) and the volume resistivity (Ω·cm) is more than 10¹³.

(Total Luminous Transmittance and Haze)

With respect to each of the specimens, a total luminous transmittance and a haze were measured in accordance with JIS K 7105.

The criteria for the evaluation of the total luminous transmittance and haze are as follows. Rating ◯ indicates that a specimen has excellent transparency such that the total luminous transmittance is 80% or more and the haze is 40% or less, and rating χ indicates that a specimen has poor transparency such that the total luminous transmittance and the haze fall outside of the above respective ranges.

(Refractive Index)

With respect to each of the specimens, a refractive index was measured in accordance with JIS K 7105.

The criteria for the evaluation of the refractive index are as follows. Rating ◯ indicates that a specimen has excellent transparency such that the difference in refractive index is 0.03 or less, and rating χ indicates that a specimen has poor transparency such that the difference in refractive index is more than 0.03.

(Melt Viscosity)

A melt viscosity was measured by means of a high-load type flow tester with a nozzle diameter of 1 mmφ at a shear rate of 10 (sec⁻¹) at 200° C.

The criteria for the evaluation of the melt viscosity are as follows. Rating ◯ indicates that a specimen has a melt viscosity of 2×10³ to 8×10⁴ (poises), and rating χ indicates that a specimen has a melt viscosity of less than 2×10³ (poises) or more than 8×10⁴ (poises).

TABLE 1

| | Refractive index | | | |
|---|---|---|---|---|
| | [Weight ratio (wt %)] | | Molding properties | |
| | Styrene | Ester | Melt viscosity | Extrusion |
| | resin* | amide** | (poise) | properties |
| Example 1 | 1.56 | 1.53 | 1 × 10⁴ | Good |
| | (70) | (30) | | ◯ |
| Example 2 | 1.56 | 1.51 | 1 × 10⁴ | Good |
| | (70) | (30) | | ◯ |
| Example 3 | 1.56 | 1.53 | 8 × 10⁴ | Good |
| | (85) | (15) | | ◯ |
| Example 4 | 1.56 | 1.53 | 2 × 10³ | Good |
| | (60) | (40) | | ◯ |
| Comparative | 1.56 | 1.53 | 9 × 10⁴ | Good |
| example 1 | (90) | (10) | | ◯ |
| Comparative | 1.56 | 1.53 | 1 × 10³ | Difficult to |
| example 2 | (55) | (45) | | obtain desired |
| | | | | dimension |
| | | | | Δ |
| Comparative | 1.56 | 1.53 | 1 × 10³ | Poor dimensional |
| example 3 | (70) | (30) | | accuracy |
| | | | | X |
| Comparative | 1.56 | 1.53 | 9 × 10⁵ | Impossible to |
| example 4 | (70) | (30) | | extrude due to |
| | | | | overload |

*Dispersed polystyrene resin
**Polyether ester amide

TABLE 2

| | | | Physical | | | |
|---|---|---|---|---|---|---|
| | | | properties | Transparency | | |
| | Anti-static | | Elastic | Total | | |
| | properties | | modulus in | luminous | | |
| | ρs* | ρv** | tension | transmittance | Haze | |
| | (Ω) | (Ω:cm) | (MPa) | (%) | (%) | Appearance |
| Example 1 | 2 × 10¹¹ | 5 × 10¹¹ | 1110 | 90 | 25 | Transparent |
| | ◯ | ◯ | ◯ | ◯ | ◯ | |
| Example 2 | 2 × 10¹¹ | 5 × 10¹¹ | 1100 | 55 | 88 | Opaque |
| | ◯ | ◯ | ◯ | X | X | |
| Example 3 | 1 × 10¹² | 3 × 10¹² | 1240 | 92 | 20 | Transparent |
| | Δ | Δ | ◯ | ◯ | ◯ | |
| Example 4 | 1 × 10¹¹ | 4 × 10¹¹ | 950 | 85 | 28 | Transparent |
| | ◯ | ◯ | ◯ | ◯ | ◯ | |
| Comparative | 1 × 10¹³ | 5 × 10¹³ | 1300 | 92 | 20 | Transparent |
| example 1 | X | X | ◯ | ◯ | ◯ | |
| Comparative | 1 × 10¹⁰ | 1 × 10¹¹ | 850 | 85 | 30 | Transparent |
| example 2 | ◯ | ◯ | X | ◯ | ◯ | |
| Comparative | 1 × 10¹² | 2 × 10¹² | 1100 | 95 | 15 | Transparent |
| example 3 | Δ | Δ | ◯ | ◯ | ◯ | |
| Comparative | — | — | — | — | — | Transparent |
| example 4 | | | | | | |

ρs: Surface resistivity
ρv: Volume resistivity

As is apparent from the test results shown in Tables 1 and 2 in respect of Examples 1 to 4 and Comparative Examples 1 to 4, the composition comprising 60 to 85% by weight of a dispersed polystyrene resin and 15 to 40% by weight of a polyether ester amide and having a melt viscosity of 2×10³ to 8×10⁴ (poises) at a shear rate of 10 (sec⁻¹) at 200° C. has good extrusion property, and the extruded article obtained from the composition has good anti-static properties and excellent physical properties (strength).

Therefore, it is preferred that the resin composition for extrusion has a melt viscosity of 2×10³ to 8×10⁴ (poises) at a shear rate of 10 (sec⁻¹) at 200° C. In addition, as is apparent from Example 2, when the difference in refractive index between the dispersed polystyrene resin and the polyether ester amide exceeds 0.03, the transparency of the resultant extruded article becomes poor. Therefore, it is preferred that the difference in refractive index between the dispersed polystyrene resin and the polyether ester amide is 0.03 or less.

TABLE 3

| | Refractive index | | | |
|---|---|---|---|---|
| | [Weight ratio (wt %)] | | Molding properties | |
| | Styrene | Ester | Melt viscosity | Extrusion |
| | resin* | amide** | (poise) | properties |
| Example 5 | 1.56 | 1.53 | 1 × 10⁴ | Good |
| | (70) | (30) | | ◯ |
| Example 6 | 1.56 | 1.51 | 1 × 10⁴ | Good |
| | (70) | (30) | | ◯ |
| Example 7 | 1.56 | 1.53 | 8 × 10⁴ | Good |
| | (85) | (15) | | ◯ |
| Example 8 | 1.56 | 1.53 | 2 × 10³ | Good |
| | (60) | (40) | | ◯ |
| Comparative | 1.56 | 1.53 | 4 × 10⁴ | Good |
| example 5 | (90) | (10) | | ◯ |
| Comparative | 1.56 | 1.53 | 1 × 10³ | Difficult to |
| example 6 | (55) | (45) | | obtain desired |
| | | | | dimension |
| | | | | Δ |
| Comparative | 1.54 | 1.53 | 0.9 × 10³ | Poor dimensional |
| example 7 | (70) | (30) | | accuracy |
| | | | | X |

*Dispersed polystyrene resin
**Polyether ester amide

TABLE 4

| | | | Physical | | | |
|---|---|---|---|---|---|---|
| | | | properties | Transparency | | |
| | Anti-static | | Elastic | Total | | |
| | properties | | modulus in | luminous | | |
| | ρs* | ρv** | tension | transmittance | Haze | |
| | (Ω) | (Ω:cm) | (MPa) | (%) | (%) | Appearance |
| Example 5 | 3 × 10¹¹ | 3 × 10¹¹ | 1000 | 88 | 20 | Transparent |
| Example 6 | 5 × 10¹¹ | 4 × 10¹¹ | 950 | 70 | 50 | Opaque |
| Example 7 | 1 × 10¹² | 1 × 10¹² | 1400 | 89 | 25 | Transparent |
| Example 8 | 5 × 10¹¹ | 6 × 10¹¹ | 950 | 89 | 24 | Transparent |
| Comparative | 1 × 10¹³ | 1 × 10¹³ | 1300 | 90 | 15 | Transparent |
| example 5 | | | | | | |
| Comparative | 2 × 10¹⁰ | 3 × 10¹¹ | 800 | 80 | 35 | Transparent |
| example 6 | | | | | | |
| Comparative | 5 × 10¹² | 6 × 10¹² | 800 | 80 | 25 | Transparent |
| example 7 | | | | | | |

ρs: Surface resistivity
ρv: Volume resistivity

As is apparent from the test results shown in Tables 3 and 4 in respect of Examples 5 to 8 and Comparative Examples 5 to 7, the composition comprising 60 to 85% by weight of a non-dispersed polystyrene resin and 15 to 40% by weight of a polyether ester amide and having a melt viscosity of 2×10³ to 8×10⁴ (poises) at a shear rate of 10 (sec⁻¹) at 200° C. has good extrusion property. The extruded article obtained from the composition has good anti-static properties and excellent physical properties (strength). Therefore, it is preferred that the resin composition for extrusion has a melt viscosity of 2×10³ to 8×10⁴ (poises) at a shear rate of 10 (sec⁻¹) at 200° C.

In Example 6, when the difference in refractive index between the dispersed polystyrene resin and the polyether ester amide exceeds 0.03, the transparency of the resultant extruded article becomes poor. Therefore, it is preferred that the difference in refractive index between the dispersed polystyrene resin and the polyether ester amide is 0.03 or less.

Next, using the resin compositions (pellets) used in Examples 1 to 8 and Comparative Examples 1, 2, 5, and 6, sheets were obtained by extrusion. The results of measurements for elastic modulus in tension, surface resistivity, volume resistivity, total luminous transmittance, haze, and refractive index with respect to each of the obtained sheets are shown in Tables 5 and 6.

### EXAMPLE 9

70% by weight of a dispersed polystyrene resin (trade name: CLEAPACT TI350; Dainippon Ink & Chemicals Incorporated) and 30% by weight of a polyether ester amide (trade name: PELESTAT NC7530; Sanyo Chemical Industries, Ltd.) were mixed together. The resultant mixture was extruded by means of a co-rotating twin-screw extruder using a T-die, followed by casting, thus obtaining a sheet having a thickness of 500 μm.

### EXAMPLE 10

Shaping was conducted in the same manner as in Example 9 except that PELESTAT NC6321 (trade name; Sanyo Chemical Industries, Ltd.) was used as a polyether ester amide to obtain a sheet having a thickness of 500 μm.

### EXAMPLE 11

85% by weight of a dispersed polystyrene resin (trade name: CLEAPACT TI350; Dainippon Ink & Chemicals Incorporated) and 15% by weight of a polyether ester amide (trade name: PELESTAT NC7530; Sanyo Chemical Industries, Ltd.) were mixed together, and then shaping was conducted in the same manner as in Example 9 to obtain a sheet having a thickness of 500 μm.

### EXAMPLE 12

60% by weight of a dispersed polystyrene resin (trade name: CLEAPACT TI350; Dainippon Ink & Chemicals Incorporated) and 40% by weight of a polyether ester amide (trade name: PELESTAT NC7530; Sanyo Chemical Industries, Ltd.) were mixed together, and then shaping was conducted in the same manner as in Example 9 to obtain a sheet having a thickness of 500 μm.

### COMPARATIVE EXAMPLE 8

90% by weight of a dispersed polystyrene resin (trade name: CLEAPACT TI350; Dainippon Ink & Chemicals Incorporated) and 10% by weight of a polyether ester amide (trade name: PELESTAT NC7530; Sanyo Chemical Industries, Ltd.) were mixed together, and then shaping was conducted in the same manner as in Example 9 to obtain a sheet having a thickness of 500 μm.

### COMPARATIVE EXAMPLE 9

55% by weight of a dispersed polystyrene resin (trade name: CLEAPACT TI350; Dainippon Ink & Chemicals Incorporated) and 45% by weight of a polyether ester amide (trade name: PELESTAT NC7530; Sanyo Chemical Industries, Ltd.) were mixed together, and then shaping was conducted in the same manner as in Example 9 to obtain a sheet having a thickness of 500 μm.

TABLE 5

| | Refractive index | | | | | | |
|---|---|---|---|---|---|---|---|
| | [Weight ratio | | Physical | | | | |
| | (wt %)] | | properties | Anti-static | | Transparency | |
| | Styrene | Ester | Elastic | properties | | Total | |
| | resin* | amide** | modulus in | Surface | Volume | luminous | |
| | Difference in | | tension | resistivity | resistivity | transmittance | Haze |
| | refractive index | | (MPa) | (Ω) | (Ω · cm) | (%) | (%) |
| Example 9 | 1.56 | 1.53 | 1110 | 1 × 10¹¹ | 3 × 10¹¹ | 90 | 25 |
| | (70) | (30) | | | | | |
| | 0.03 (◯) | | ◯ | ◯ | | ◯ | |
| Example | 1.56 | 1.51 | 1100 | 2 × 10¹¹ | 3 × 10¹¹ | 55 | 88 |
| 10 | (70) | (30) | | | | | |
| | 0.05 (X) | | ◯ | ◯ | | X | |
| Example | 1.56 | 1.53 | 1240 | 5 × 10¹² | 7 × 10¹² | 92 | 20 |
| 11 | (85) | (15) | | | | | |
| | 0.03 (◯) | | ◯ | Δ | | ◯ | |
| Example | 1.56 | 1.53 | 950 | 3 × 10⁹ | 5 × 10⁹ | 85 | 28 |
| 12 | (60) | (40) | | | | | |
| | 0.03 (◯) | | ◯ | ◯ | | ◯ | |
| Comp. | 1.56 | 1.53 | 1300 | 4 × 10¹³ | 7 × 10¹³ | 92 | 20 |
| example 8 | (90) | (10) | | | | | |
| | 0.03 (◯) | | ◯ | X | | ◯ | |
| Comp. | 1.56 | 1.53 | 850 | 7 × 10⁸ | 1 × 10⁹ | 85 | 30 |
| example 9 | (55) | (45) | | | | | |

| | | | |
|---|---|---|---|
| 0.03 (◯) | X | ◯ | ◯ |

*Dispersed polystyrene resin
**Polyether ester amide

As shown in Table 5, the sheet obtained from the composition prepared by mixing 60 to 85% by weight of a dispersed polystyrene resin and 15 to 40% by weight of a polyether ester amide has good anti-static properties and excellent physical properties (strength). In addition, the transparency of the sheet is preferred since the difference in refractive index between the dispersed polystyrene resin and the polyether ester amide is 0.03 or less.

As shown in Tables 2 and 5, when the weight ratio of the dispersed polystyrene resin to polyether ester amide is 60 to 70% by weight: 30 to 40% by weight, the sheet has a surface resistivity (Ω) of less than 1×10¹² and a volume resistivity (Ω·cm) of less than 1×10¹², so that a better antistat effect can be obtained.

Next, using the resin compositions (pellets) used in Examples 5 to 8 and Comparative Examples 5 and 6, sheets each having a thickness of 500 μm were obtained by extrusion in the same manner as in Example 9. The results of measurements for elastic modulus in tension, surface resistivity, volume resistivity, total luminous transmittance, haze, and refractive index with respect to each of the obtained sheets are shown in Table 6.

TABLE 6

| | Refractive index | | | | | | |
|---|---|---|---|---|---|---|---|
| | [Weight ratio | | Physical | | | | |
| | (wt %)] | | properties | Anti-static | | Transparency | |
| | Styrene | Ester | Elastic | properties | | Total | |
| | resin* | amide** | modulus in | Surface | Volume | luminous | |
| | Difference in | | tension | resistivity | resistivity | transmittance | Haze |
| | refractive index | | (MPa) | (Ω) | (Ω · cm) | (%) | (%) |
| Example | 1.56 | 1.53 | | 3 × 10¹¹ | 4 × 10¹¹ | 80 | 30 |
| 13 | (70) | (30) | | | | | |
| | 0.03 (◯) | | ◯ | ◯ | | ◯ | |
| Example | 1.56 | 1.51 | 1100 | 5 × 10¹¹ | 4 × 10¹¹ | 65 | 70 |
| 14 | (70) | (30) | | | | | |
| | 0.05 (X) | | ◯ | ◯ | | X | |
| Example | 1.56 | 1.53 | 1240 | 1 × 10¹² | 1 × 10¹² | 85 | 35 |
| 15 | (85) | (15) | | | | | |
| | 0.03 (◯) | | ◯ | Δ | | ◯ | |
| Example | 1.56 | 1.53 | 950 | 8 × 10¹¹ | 9 × 10¹¹ | 85 | 30 |
| 16 | (60) | (40) | | | | | |
| | 0.03 (◯) | | ◯ | ◯ | | ◯ | |
| Comp. | 1.56 | 1.53 | 1300 | 4 × 10¹³ | 5 × 10¹³ | 83 | 25 |
| example | (90) | (10) | | | | | |
| 10 | 0.03 (◯) | | ◯ | X | | ◯ | |
| Comp. | 1.56 | 1.53 | 850 | 9 × 10⁸ | 1 × 10⁹ | 75 | 30 |
| example | (55) | (45) | | | | | |

| | | | | |
|---|---|---|---|---|
| 11 | 0.03 (◯) | X | ◯ | ◯ |

*Dispersed polystyrene resin
**Polyether ester amide

As shown in Table 6, the sheet obtained from the composition prepared by mixing 60 to 85% by weight of a non-dispersed polystyrene resin and 15 to 40% by weight of a polyether ester amide has the combination of good anti-static properties and physical properties (strength). In addition, the transparency of the sheet is preferred since the difference in refractive index between the polystyrene resin and the polyether ester amide is 0.03 or less.

As shown in Tables 4 and 6, when the weight ratio of the polystyrene resin to polyether ester amide is 60 to 70% by weight: 30 to 40% by weight, the sheet has a surface resistivity (Ω) of less than 1×10¹² and a volume resistivity (Ω·cm) of less than 1×10¹², so that a better antistat effect can be obtained.

The present embodiment has the following effects.

(1) A resin composition comprised mainly of 60 to 85% by weight of a dispersed polystyrene resin and 15 to 40% by weight of a polyether ester amide and having a melt viscosity of 2×10³ to 8×10⁴ (poises) at a shear rate of 10 (sec⁻¹) at 200° C. was formed. An extruded article formed from the resin composition has excellent permanent anti-static properties and molding properties.

(2) A resin composition comprised mainly of 60 to 85% by weight of a non-dispersed polystyrene resin and 15 to 40% by weight of a polyether ester amide and having a melt viscosity of 2×10³ to 8×10⁴ (poises) at a shear rate of 10 (sec⁻¹) at 200° C. was formed. An extruded article formed from the resin composition has excellent permanent anti-static properties and molding properties.

(3) The dispersed polystyrene resin or non-dispersed polystyrene resin had transparency, and the difference in refractive index between the polystyrene resin and the polyether ester amide was 0.03 or less. Thus, an extruded article having good transparency can be easily obtained.

(4) An extruded article is produced from the resin composition as a material for shaping. Therefore, the extruded article has excellent permanent anti-static properties and molding properties as well as good transparency.

(5) An anti-static sheet comprised mainly of 60 to 85% by weight of a dispersed polystyrene resin and 15 to 40% by weight of a polyether ester amide is formed. The sheet has good anti-static properties and vacuum formability.

(6) An anti-static sheet comprised mainly of 60 to 85% by weight of a non-dispersed polystyrene resin and 15 to 40% by weight of a polyether ester amide is formed. The sheet has good permanent anti-static properties and vacuum formability.

(7) The dispersed polystyrene resin or non-dispersed polystyrene resin has transparency, and the difference in refractive index between the polystyrene resin and the polyether ester amide is 0.03 or less. Thus, the anti-static sheet has good transparency.

(8) When trays, housings, or cases formed using the extruded article and anti-static sheet are used for storage, transfer, or mounting to containers of electronic materials, such as ICs, LSIs, silicon wafers, hard disks, liquid crystal substrates, and electronic parts, these electronic parts can be prevented from suffering damage and contamination due to static electricity. In addition, by using the extruded article and sheet to impart anti-static properties to general plastic tubular materials, plate materials, and profile shape members, the range of applications of the products can be extended.

Next, the second embodiment of the present invention will be described. In the present embodiment, explanation is made mainly on the points different from the first embodiment, and the explanation on the same matters is omitted in order to avoid overlaps.

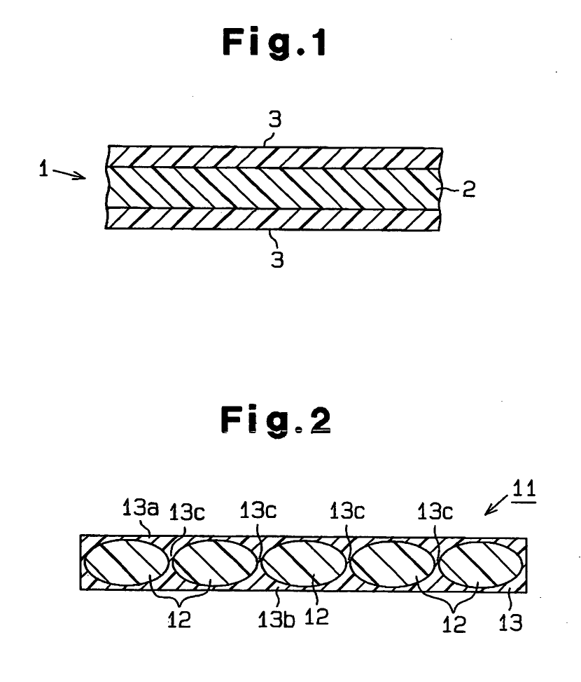

As shown in FIG. 1, an anti-static sheet 1 comprises a core layer 2 and outer layers 3 formed on both surfaces of the core layer 2. The core layer 2 and the outer layer 3 are formed by co-extrusion. The core layer 2 plays a role to dissipate static electricity in the thicknesswise direction of the anti-static sheet 1. The outer layer 3 has a function to dissipate static electricity along the surface of the anti-static sheet 1.

The core layer 2 is formed by dispersing a polyether ester amide in a thermoplastic resin. The core layer 2 has an elastic modulus in tension of 900 MPa or more at ordinary temperature (23° C.) and has a volume resistivity of 10¹² Ω·cm or less. An elastic modulus in tension was measured as a criterion for the strength of a carrier tray formed from the anti-static sheet 1 by vacuum forming. As a result, it has been found that, when the elastic modulus in tension is 900 MPa or more, no dent or distortion occurs in the stacked trays. Therefore, from a practical point of view, it is preferred that the tray has a strength such that the elastic modulus in tension is 900 MPa or more.

When a mixture of the polyether ester amide and the thermoplastic resin is required to have transparency, the difference in refractive index between the polyether ester amide and the thermoplastic resin is adjusted to be 0.03 or less. It is preferred that, as the thermoplastic resin, the non-dispersed polystyrene resin in the first embodiment is used. As the polyether ester amide, commercially available one having a refractive index of 1.53 is preferably used.

The volume resistivity indicates the resistivity when static electricity is dissipated in the thicknesswise direction of the sheet. For obtaining a sheet having a volume resistivity of 10¹² Ω·cm or less and having a high elastic modulus in tension, it is desired that the polyether ester amide and the thermoplastic resin are mixed with each other in a ratio of 25 to 50% by weight to 50 to 75% by weight.

The outer layer 3 is formed from a material obtained by dispersing a polyether ester amide in a thermoplastic resin. The outer layer 3 has a surface resistivity of 10¹⁰ Ω or less. For obtaining such a surface resistivity, it is desired that the polyether ester amide and the thermoplastic resin are mixed with each other in a ratio of 35 to 70% by weight to 65 to 30% by weight. The same polyether ester amide as that used in the core layer 2 is used.

With respect to the thickness of each of the core layer 2 and the outer layer 3, there is no particular limitation as long as the anti-static sheet 1 has the above-mentioned properties. When taking a reduction in cost for materials and processability of the anti-static sheet 1 into consideration, the thickness ratio of the outer layer 3:core layer 2:outer layer 3 is preferably 0.01 to 0.50 mm:0.50 to 1.00 mm:0.01 to 0.50 mm. Both the outer layers 3 do not necessarily have the same thickness.

From the viewpoint of obtaining excellent interface adhesion in the co-extrusion of the anti-static sheet 1, it is preferred that the thermoplastic resin used in the core layer 2 and the thermoplastic resin used in the outer layer 3 are the same. When the thermoplastic resins used in the core layer 2 and the outer layer 3 can adhere to one another by heating, they may be different. The equipment for co-extrusion may be a general co-extrusion apparatus. For example, thermoplastic resin compositions for the core layer 2 and the outer layer 3 are individually fed to a head by means of two different extruders. The thermoplastic resin compositions are mixed by a feed block or multi-head and shaped into a sheet form. The sheet 1 is cooled and solidified through a casting roll and wound up.

The ratio of styrene monomer to (meth)acrylate monomer is selected so that the refractive index is close to the refractive index of the polyether ester amide. Generally, the ratio of styrene monomer to (meth)acrylate monomer is appropriately adjusted in the range of from 30 to 90:10 to 70% by weight while taking into consideration the melt viscosity and other properties of the resultant resin composition.

In the present embodiment, like in the first embodiment, most preferred styrene monomer is styrene, and, on the other hand, most preferred (meth)acrylate monomers are methyl methacrylate (MMA) and butyl acrylate (BA).

Hereinbelow, the present embodiment will be described in more detail with reference to the following Examples and Comparative Examples.

### EXAMPLE 21

In the extrusion of the core layer 2, mixed pellets of 35 parts by weight of a polyether ester amide (trade name: PELESTAT NC7530; Sanyo Chemical Industries, Ltd.) and 65 parts by weight of a non-dispersed polystyrene resin (trade name: CLEAPACT TI350; Dainippon Ink & Chemicals Incorporated) were used. The pellets were fed to a head for sheet by means of a 40 mm co-rotating twin-screw extruder. The refractive index of the polyether ester amide was 1.53, and the refractive index of the non-dispersed polystyrene resin was 1.56.

In the outer layer 3, mixed pellets of 40 parts by weight of a polyether ester amide (trade name: PELESTAT NC7530; Sanyo Chemical Industries, Ltd.) and 60 parts by weight of a non-dispersed polystyrene resin (trade name: CLEAPACT TI350; Dainippon Ink & Chemicals Incorporated) were used. The pellets were fed to the head by means of a 90 mm co-rotating twin-screw extruder.

The resin compositions individually fed were mixed together in the head. The thickness ratio of the outer layer 3:core layer 2:outer layer 3 was 0.2 mm:0.6 mm:0.2 mm, and a sheet having a thickness of 1 mm was obtained.

### EXAMPLE 22

A copolymerized polyester (PETG; Eastman Chemical Company) was used instead of the non-dispersed polystyrene resin described in Example 21. With the exception of the above, the procedures of Example 21 were repeated analogously to obtain a sheet having a thickness of 1 mm. The refractive index of the copolymerized polyester was 1.58.

### COMPARATIVE EXAMPLE 21

Mixed pellets of 40 parts by weight of a polyether ester amide (trade name: PELESTAT NC7530; Sanyo Chemical Industries, Ltd.) and 60 parts by weight of a non-dispersed polystyrene resin (trade name: CLEAPACT TI350; Dainippon Ink & Chemicals Incorporated) were used in the forming of the core layer 2. With the exception of the above, the procedures of Example 21 were repeated analogously to obtain a sheet having a thickness of 1 mm.

### COMPARATIVE EXAMPLE 22

Mixed pellets of 40 parts by weight of a polyether ester amide (trade name: PELESTAT NC7530; Sanyo Chemical Industries, Ltd.) and 60 parts by weight of a non-dispersed polystyrene resin (trade name: CLEAPACT TI350; Dainippon Ink & Chemicals Incorporated) were used in the forming of the core layer 2. Mixed pellets of 30 parts by weight of a polyether ester amide (trade name: PELESTAT NC7530; Sanyo Chemical Industries, Ltd.) and 60 parts by weight of a non-dispersed polystyrene resin (trade name: CLEAPACT TI350; Dainippon Ink & Chemicals Incorporated) were used for the outer layer 3. With the exception of the above, the procedures of Example 21 were repeated analogously to obtain a sheet having a thickness of 1 mm.

The results of measurements for elastic modulus in tension, surface resistivity, volume resistivity, total luminous transmittance, haze, and refractive index with respect to each of the specimens in Examples 21 and 22 and Comparative Examples 21 and 22 are shown in Tables 7 and 8. In the measurements, the same measurement tests and evaluations as those in the first embodiment were used.

TABLE 7

| | Physical | | | | | |
|---|---|---|---|---|---|---|
| | properties | | | Transparency | | |
| | Elastic | Anti-static | | Total | | |
| | modulus in | properties | | luminous | | Difference |
| | tension | ρs* | ρv** | transmittance | Haze | in refractive |
| | (MPa) | (Ω) | (Ω · cm) | (%) | (%) | index |
| Example 21 | 900 | 8 × 10⁸ | 8 × 10¹¹ | 90 | 25 | 0.03 |
| Example 22 | 1100 | 8 × 10⁸ | 7 × 10¹¹ | 50 | 90 | 0.05 |
| Comparative | 750 | 8 × 10⁹ | 9 × 10⁹ | 85 | 28 | 0.03 |
| example 21 | | | | | | |
| Comparative | 950 | 8 × 10¹² | 8 × 10¹² | 90 | 25 | 0.03 |
| example 22 | | | | | | |

ρs: Surface resistivity
ρv: Volume resistivity

TABLE 8

| | Anti-static | | |
|---|---|---|---|
| | properties | Sheet strength | Transparency |
| Example 21 | ◯ | ◯ | ◯ |
| Example 22 | ◯ | ◯ | X |
| Comparative | ◯ | X | ◯ |
| example 21 | | | |
| Comparative | X | ◯ | ◯ |
| example 22 | | | |

As shown in Tables 7 and 8, when the core layer 2 has a volume resistivity of 10¹² (Ω·cm) or less and the outer layer 3 has a surface resistivity 10¹⁰ Ω or less, the sheet has good anti-static properties. When the anti-static sheet 1 has an elastic modulus in tension of 900 MPa or more, a strength required for vacuum forming or pressure forming is imparted to the anti-static sheet 1. In addition, when each of the polyether ester amide and the thermoplastic resin has transparency and the difference in refractive index between the polyether ester amide and the thermoplastic resin is 0.03 or less, good transparency can be obtained.

The present embodiment has the following effects.

(1) The anti-static sheet 1 comprises the core layer 2 having a function of dissipating static electricity in the thicknesswise direction of the anti-static sheet 1 and the outer layer 3 having a function of dissipating static electricity along the surface of the anti-static sheet 1. Therefore, a shaped article having excellent anti-static properties and being capable of preventing occurrence of deformation which is disadvantageous in carrying can be easily shaped by vacuum forming or pressure forming. By using the resultant shaped article in storage or transfer of electronic materials, such as ICs, LSIs, silicon wafers, hard disks, liquid crystal substrates, and electronic parts, these electronic parts can be prevented from suffering damage and contamination due to static electricity.

(2) The anti-static sheet 1 is produced by co-extrusion of the core layer 2 and the outer layer 3. Therefore, the production of the anti-static sheet 1 is simple, and thus the sheet 1 can be easily produced.

(3) Both the polyether ester amide and the thermoplastic resin have transparency, and the difference in refractive index between the polyether ester amide and the thermoplastic resin is adjusted to 0.03 or less. Therefore, the anti-static sheet 1 having good transparency can be formed.

(4) The thermoplastic resin is a copolymer comprising a styrene monomer and a (meth)acrylate monomer. Therefore, it is easy to secure dispersibility of the polyether ester amide and physical properties required for the shaped article.

(5) A mixing ratio between the polyether ester amide and the thermoplastic resin constituting the core layer 2 is such that the amount of the polyether ester amide is 25 to 50% by weight and the amount of the thermoplastic resin is 75 to 50% by weight. Therefore, the anti-static sheet 1 having a volume resistivity of 10¹² Ω·cm or less and having a high elastic modulus in tension can be formed.

(6) A mixing ratio of the polyether ester amide and the thermoplastic resin constituting the outer layer 3 is such that the amount of the polyether ester amide is 35 to 70% by weight and the amount of the thermoplastic resin is 30 to 65% by weight. Therefore, the anti-static sheet 1 having a surface resistivity of 10¹⁰ Ω or less can be easily formed.

(7) The thickness ratio of the outer layer 3:core layer 2:outer layer 3 is 0.01 to 0.50 mm:0.50 to 1.00 mm:0.01 to 0.50 mm. Therefore, the anti-static sheet 1 has good vacuum formability and can be produced at low cost.

Next, the third embodiment of the present invention will be described. In the present embodiment, explanation is made mainly on the points different from the above embodiments, and the explanation on the same matters is omitted in order to avoid overlaps.

As shown in FIG. 2, an anti-static sheet 11 has a core layers 12 comprised of a thermoplastic resin and an outer layer 13 formed so that the core layers 12 are disposed between the outer layer 13. The outer layer 13 is formed from a thermoplastic resin containing therein an electrically conductive filler. The outer layer 13 has a surface portion 13a, a back surface portion 13b, and a connection portion 13c for connecting the surface portion 13a to the back surface portion 13b. In the present embodiment, the outer layer 13 is formed so that the surface portion 13a and the back surface portion 13b are connected to each other also at both end portions in the widthwise direction of the anti-static sheet 11.

A plurality of the core layers 12 each having an elliptical cross-section are covered with the outer layer 13. The connection portion 13c of the outer layer 13 is provided between the adjacent core layers 12. Each of the core layer 12 and the outer layer 13 is formed by co-extrusion.

The core layer 12 determines mainly the physical properties and molding properties of the anti-static sheet 11. With respect to the type of material for the core layer 12, there is no particular limitation as long as it is a thermoplastic resin. Any thermoplastic resin may be used as long as a carrier tray formed from the anti-static sheet 11 by vacuum forming has a stiffness. Such a stiffness may be obtained if the elastic modulus in tension at ordinary temperature (23° C.) is 900 MPa or more. As the thermoplastic resin, a polystyrene resin or an ABS resin is preferred.

The outer layer 13 mainly dissipates static electricity along the surface of the anti-static sheet 11 and dissipates static electricity in the thicknesswise direction of anti-static sheet 11. When the anti-static sheet 11 has a surface resistivity ρs of 10¹⁰ Ω or less and a volume resistivity ρv of 10¹⁰ Ω·cm or less, the sheet has a remarkable antistat effect free of a problem about the anti-static properties. When the anti-static sheet 11 has a surface resistivity ρs of 10¹² Ω or less and a volume resistivity ρv of 10¹² Ω·cm or less, the sheet has an antistat effect and has no practical problem. When the anti-static sheet 11 has a surface resistivity ρs of more than 10¹² Ω or a volume resistivity ρv of more than 10¹² Ω·cm, the sheet has an antistat effect but it has a problem about the anti-static properties. Therefore, the outer layer 13 needs to meet a requirement that the anti-static sheet 11 has a surface resistivity ρs of 10¹² Ω or less and a volume resistivity ρv of 10¹² Ω·cm or less.

The type of the material for the outer layer 13 may be a thermoplastic resin containing therein an electrically conductive filler. When an economical aspect is taken into consideration, it is preferred that the material for the outer layer 13 is a polystyrene resin or ABS resin containing therein carbon black. It is preferred that a mixing ratio of the carbon black and the thermoplastic resin is such that the amount of the carbon black is 5 to 30% by weight and the amount of the thermoplastic resin is 70 to 95% by weight.

In the case where the anti-static sheet 11 is required to have transparency, it is preferred to use a polystyrene resin or ABS resin having added thereto (dispersed therein) a polyether ester amide. It is preferred that the mixing ratio of the polyether ester amide and the thermoplastic resin is adjusted so that the difference in refractive index between the polyether ester amide and the thermoplastic resin is 0.03 or less. For obtaining the outer layer 13 having a surface resistivity of 10¹⁰ Ω or less, it is preferred that a mixing ratio of the polyether ester amide and the thermoplastic resin is such that the amount of the polyether ester amide is 35 to 70% by weight and the amount of the thermoplastic resin is 30 to 65% by weight. As the polystyrene resin, a copolymer comprising a styrene monomer and a (meth)acrylate monomer is preferably used. As the polyether ester amide, commercially available one having a refractive index of 1.53 is preferably used.

In the present embodiment, like in the first embodiment, the most preferred styrene monomer is styrene, and, on the other hand, the most preferred (meth)acrylate monomers are methyl methacrylate (MMA) and butyl acrylate (BA).

When a polystyrene resin having a high impact resistance is used as the thermoplastic resin constituting the materials for the core layer 12 and the outer layer 13, it is easy to secure physical properties and molding properties required for the anti-static sheet 11. As the polystyrene resin having high impact resistance, high impact polystyrene (HIPS) or a dispersed polystyrene resin is used.

When a cost for materials and a thickness of the sheet for vacuum forming are taken into consideration, it is preferred that the thickness of the core layer 12 and the outer layer 13 constituting the anti-static sheet 11 falls within the below-described range. The thickness of the core layer 12 and the outer layer 13 means the average thickness of the surface portion 13a and the average thickness of the back surface portion 13b of the core layer 12 and the outer layer 13 in the widthwise direction of the anti-static sheet 11. It is not necessary that the thickness of the surface portion 13a and the thickness of the back surface portion 13b be the same.

The thickness ratio of the outer layer 13:core layer 12:outer layer 13 is 0.01 to 0.50 mm:0.50 to 1.00 mm:0.01 to 0.50 mm.

It is preferred that the number of connection portion(s) 13c of the outer layer 13 is three or more when the surface resistivity ρs of the outer layer 13 is at a 10¹⁰ Ω level, and is one or more when the surface resistivity ρs of the outer layer 13 is at a 10⁶ Ω level. The total width of connection portions 13c is in the range of from 1/20 to ⅕ of the width of the anti-static sheet 11.

Next, a method for producing the anti-static sheet 11 having the above-mentioned structure is described below. The anti-static sheet 11 is formed by co-extrusion. When the anti-static sheet 11 is formed by co-extrusion, from the viewpoint of obtaining interface adhesion between the layers, it is preferred that the thermoplastic resin used in the core layer 12 and the thermoplastic resin used in the outer layer 13 are the same. When the thermoplastic resins used in the core layer 12 and the outer layer 13 can adhere to one another by heating, they may be different.

The equipment for co-extrusion may be a general co-extrusion apparatus. For example, a resin for the core layer 12 is extruded in a molten form by means of one of two extruders (not shown) while a resin for the outer layer 13 is extruded in a molten form by means of another one. For example, both the molten resins are mixed together in a die (head) using a feed block and then shaped into a sheet form. Then, the resultant molten resin is cooled and solidified through a casting roll and wound up, thus producing the anti-static sheet 11.

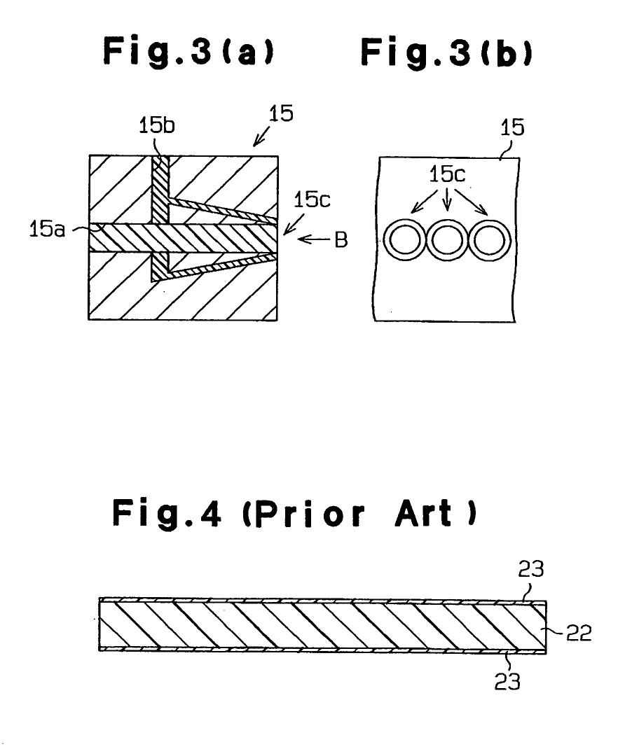

As shown in FIGS. 3(A) and 3(B), a feed block 15 has a first feed port 15a for feeding a resin for the core layer 12, a second feed port 15b for feeding a resin for the outer layer 13, and a plurality of outlets 15c. The resin for the core layer 12 fed through the first feed port 15a is extruded into a cylindrical shape. The resin for the outer layer 13 fed through the second feed port 15b is extruded so as to cover the extruded product in a cylindrical shape.

The extruded product is pressed when it passes through unillustrated rollers, so that the core layers 12 each having an elliptical cross-section are formed.

Hereinbelow, the present embodiment will be described in more detail with reference to the following Examples and Comparative Examples.

### EXAMPLE 31

HIPS (trade name: H8117; A&M Styrene) was used in the core layer 12, and HIPS (trade name: HT60; A&M Styrene) containing 25% by weight of carbon black was used in the outer layer 13.

The mixing for the core layer 12 is conducted by melting by means of an unillustrated extruder having a nozzle diameter of 65 mmφ, and the mixing for the outer layer 13 is conducted by melting by means of an unillustrated extruder having a nozzle diameter of 40 mmφ. The molten resins of shaping materials for the respective layers are fed to the feed block 15, and shaped through a head fixed on the feed block 15 into a sheet form, and then cooled and solidified, and wound up to form the anti-static sheet 11. In the sheet 11, the thickness of the outer layer 13 was 30 μm, and the thickness of the core layer 12 was 240 μm. In the outer layer 13, five connection portions 13c were provided relative to the 640 μm width of the sheet 11.

### EXAMPLE 32

In the extrusion of the core layer 12, a dispersed polystyrene resin (trade name: CLEAPACT TI350; Dainippon Ink & Chemicals Incorporated) was used. In the outer layer 13, 40 parts by weight of a polyether ester amide (trade name: PELESTAT NC7530; Sanyo Chemical Industries, Ltd.) and 60 parts by weight a non-dispersed polystyrene resin (trade name: CLEAPACT TI350; Dainippon Ink & Chemicals Incorporated) were used.

The mixing for the core layer 12 was conducted by means of the extruder having a nozzle diameter of 65 mmφ, and the mixing for the outer layer 13 was conducted by means of the extruder having a nozzle diameter of 40 mmφ. The molten resins of shaping materials for the respective layers were fed to the feed block 15, and shaped through a head fixed on the feed block 15 into a sheet form, and then cooled and solidified, and wound up to form the anti-static sheet 11. In the sheet 11, the thickness of the outer layer 13 was 30 μm, and the thickness of the core layer 12 was 240 μm. In the outer layer 13, five connection portions 13c were provided relative to the 640 μm width of the sheet 11.

### COMPARATIVE EXAMPLE 31

As materials for the core layer 12 and the outer layer 13, the materials having the same formulations as those in Example 31 were used. A feed block having a horizontal slit for forming a sheet in which the mixed portion of the resin for the core layer 12 and the resin for the outer layer 13 was in a sandwich form. With the exception described above, a sheet having a three-layer structure was formed using the same equipment as that used in Example 31. In the sheet formed, the thickness of the outer layer 13 was 30 μm, and the thickness of the core layer 12 was 240 μm.

### COMPARATIVE EXAMPLE 32

As materials for the core layer 12 and the outer layer 13, the materials having the same formulations as those in Example 32 were used. A feed block having a horizontal slit for forming a sheet in which the mixed portion of the resin for the core layer 12 and the resin for the outer layer 13 was in a sandwich form. With the exception described above, a sheet having a three-layer structure was formed using the same equipment as that used in Example 32. In the sheet formed, the thickness of the outer layer 13 was 30 μm, and the thickness of the core layer 12 was 240 μm.

Using the specimens in Examples 31 and 32 and Comparative Examples 31 and 32, evaluations for elastic modulus in tension, surface resistivity, volume resistivity, total luminous transmittance, and haze were made in accordance with the above-mentioned methods for measurement. The criteria for the evaluation of the surface resistivity and volume resistivity are as follows. Rating ◯ indicates that a specimen has an antistat effect free of a problem about the anti-static properties such that the surface resistivity ρs is 10¹⁰ Ω or less and the volume resistivity ρv is 10¹⁰ Ω·cm or less, rating Δ indicates that a specimen has hardly perfect antistat effect such that the surface resistivity ρs is 10¹² Ω or less and the volume resistivity ρv is 10¹² Ω·cm or less, and rating χ indicates that a specimen has a problem about the anti-static properties such that the surface resistivity ρs is more than 10¹² Ω or the volume resistivity ρv is more than 10¹² Ω·cm.

The results are shown in Table 9.

TABLE 9

| | Physical | | | | |
|---|---|---|---|---|---|
| | properties | Anti-static | | Transparency | |
| | Elastic modulus | properties | | Total | |
| | in tension | ρs* | ρv** | luminous | |
| | (MPa) | (Ω) | (Ω · cm) | transmittance (%) | Haze (%) |
| Example 31 | 950 | 8 × 10⁵ | 8 × 10⁹ | 1 | — |
| | ◯ | ◯ | | X | |
| Example 32 | 1100 | 8 × 10¹⁰ | 7 × 10¹¹ | 85 | 30 |
| | ◯ | Δ | | ◯ | |
| Comparative | 1000 | 8 × 10⁶ | 9 × 10¹⁴ | 1 | — |
| example 31 | ◯ | X | | X | |
| Comparative | 1050 | 8 × 10¹⁰ | 8 × 10¹⁴ | 80 | 35 |

| | | | |
|---|---|---|---|
| example 32 | ◯ | X | ◯ |

ρs: Surface resistivity
ρv: Volume resistivity

As shown in Table 9, in Comparative Examples 31 and 32, the sheet has a volume resistivity ρv of more than 10¹² Ω·cm, and the anti-static properties of the sheet are unsatisfactory. Particularly, when comparison is made between Example 32 and Comparative Example 31, it is found that, when the connection portion 13c is not present in the outer layer 13, the volume resistivity ρv is considerably increased, and, when the connection portion 13c is present, the volume resistivity ρv becomes a desired value even though the surface resistivity ρs is not small.

The present embodiment has the following effects.

(1) By providing the connection portion 13c with the anti-static sheet 11, the volume resistivity of the sheet 11 is lowered even when no electrically conductive filler is added to the core layer 12. Consequently, a shaped article having excellent permanent anti-static properties and being capable of preventing occurrence of deformation during carrying of the shaped article can be easily formed from the sheet 11 by vacuum forming or pressure forming. By using the resultant shaped article in storage or transfer of electronic materials, such as ICs, LSIs, silicon wafers, hard disks, liquid crystal substrates, and electronic parts, these electronic parts can be prevented from suffering damage and contamination due to static electricity.

(2) The anti-static sheet 11 is produced by co-extrusion of the core layer 12 and the outer layer 13, and therefore the anti-static sheet 11 can be easily produced.

(3) When carbon black is used as an electrically conductive filler to be added to the thermoplastic resin used in the outer layer 13, the cost for production can be lowered, as compared to the cost in the case where a permanent anti-static polymer (e.g., a polyether ester amide) is used as the filler.

(4) When a polystyrene resin having high impact resistance is used, it is easy to secure physical properties and molding properties required for the sheet.

(5) When a polystyrene resin or a transparent ABS resin is used in the core layer 12 and a polystyrene resin or transparent ABS resin having added thereto a polyether ester amide is used in the outer layer 13, a shaped article having good transparency can be easily obtained.

(6) When a non-dispersed polystyrene resin is used as the polystyrene resin, both dispersibility of the polyether ester amide and physical properties required for the shaped article can be easily secured.

(7) When a mixing ratio of the polyether ester amide and the thermoplastic resin as materials for the outer layer 13 is such that the amount of the polyether ester amide is 35 to 70% by weight and the amount of the thermoplastic resin is 65 to 30% by weight, a sheet having a surface resistivity of 10¹⁰ Ω or less can be formed.

(8) With respect to the thickness of each of the core layer 12 and the outer layer 13, the thickness ratio of the outer layer 13:core layer 12:outer layer 13 is 0.01 to 0.50 mm:0.50 to 1.00 mm:0.01 to 0.50 mm. Therefore, anti-static sheet 11 has good vacuum formability and can be formed at low cost.

Next, the forth embodiment of the present invention will be described. In the present embodiment, explanation is made mainly on the points different from the above embodiments, and the explanation on the same matters is omitted in order to avoid overlaps.

The anti-static sheet comprises a polystyrene sheet base material or ABS sheet base material having on at least one surface a conductive layer. The conductive layer is comprised mainly of a resin composition comprising 15 to 75 parts by mass of a polyether ester amide relative to 100 parts by mass of a polystyrene resin, wherein the difference in refractive index between the polystyrene resin and the polyether ester amide is less than 0.03.

The term “transparency” means that an object contained in a container formed by shaping the sheet can be confirmed by means of an optical sensor or an image analysis from the outside of the container. For example, when a sheet or a container has a transmittance of 85% or more and has a haze of less than 50, the sheet or container is transparent.

The anti-static sheet has a surface resistivity in the range of from 10⁹ to 10¹² Ω. The surface resistivity is indicated by a value as measured in accordance with JIS-K6911 by means of an ultra insulation meter at 23° C. at a humidity of 50%. When a sheet having a surface resistivity in the above range is used, the insulation between an electronic circuit board and a metallic housing can be kept.

The polystyrene sheet base material used in the present embodiment is comprised mainly of a transparent polystyrene resin. As the polystyrene resin, the dispersed polystyrene resin used in the first embodiment is used.

In the present embodiment, like in the first embodiment, the most preferred styrene monomer is styrene, and, on the other hand, the most preferred (meth)acrylate monomers are methyl methacrylate (MMA) and butyl acrylate (BA).

As the dispersed polystyrene resin, in addition to the resin described in the first embodiment, “DENKA TX POLYMER TX100-300L”, manufactured by Denki Kagaku Kogyo Kabushiki Kaisha, and “Estyrene MS-200”, manufactured by Nippon Steel Chemical Group, are used.

The ABS sheet base material is comprised mainly of a transparent ABS resin. For obtaining a transparent ABS resin, generally, the refractive index of a copolymer of styrene and methyl methacrylate is adjusted so that it is the same as that of the rubber component.

From the viewpoint of obtaining a container having durability, it is preferred that the polystyrene sheet base material or ABS sheet base material has durability of 3000 times or more as measured by an MIT (Massachusetts Institute of Technology) folding endurance test described in JIS-P8115. Even when a container formed by shaping the sheet base material having durability of 3000 times or more is used ten times or more, no crack or cutout is caused in the container. In these sheet base materials, other additives can be appropriately added as long as the effect of the present invention is not impaired.

The anti-static sheet has a conductive layer or conductive layers on one surface or both surfaces of the sheet base material. The conductive layer is comprised mainly of a resin composition comprising 15 to 75 parts by mass of a polyether ester amide as a conductive agent relative to 100 parts by mass of a polystyrene resin. When the content of the polyether ester amide is less than 15 parts by mass, a sheet having a desired surface resistivity cannot be obtained. On the other hand, when the content of the polyether ester amide exceeds 75 parts by mass, it is difficult to form a film usable as a film (sheet) for shaping. The polyether ester amide has excellent anti-static properties and transparency.

As the polystyrene resin used in the conductive layer, one which is similar to that mentioned above as the main component of the polystyrene sheet base material is used. For improving the compatibility between the polystyrene resin and the polyether ester amide, an agent for improving the compatibility, such as a modified vinyl polymer, may be added as long as the transparency and the antistat effect are not impaired.

The polyether ester amide preferably used in the present embodiment is the same as the resins used in the above embodiments. However, it is necessary that the difference in refractive index between the polystyrene resin and the polyether ester amide be less than 0.03, and the type of the polyether ester amide is appropriately selected according to the type of the polystyrene resin used.

It is preferred that the thickness ratio of the conductive layer and the base material in the anti-static sheet is, for example, in the range of from 1:5 to 1:10, in terms of the thickness ratio of the conductive layer to the base material because the lower cost can be realized.

For example, a polystyrene resin or an ABS resin as a material for the base material, and a resin composition comprising a polystyrene resin and a polyether ester amide as a material for the conductive layer are individually fed to two different extruders, and mixed together in a head or a feed block and subjected to co-extrusion into a sheet form to form an anti-static sheet. Alternatively, a conductive layer comprised mainly of a resin composition for conductive layer is preliminarily formed. This conductive layer may be laminated onto at least one surface of the polystyrene sheet base material or ABS sheet base material by a heat treatment or through an adhesive layer to form an anti-static sheet.

(Examples)

Hereinbelow, the present embodiment will be described in more detail with reference to the following Examples. With respect to each of the specimens in the Examples, a surface resistivity, a total luminous transmittance, a haze, folding endurance, and container durability were measured. The surface resistivity, total luminous transmittance, and haze of each specimen were measured and evaluated under the same conditions as those used in the above embodiments.

The folding endurance of an anti-static sheet is determined in accordance with “Test using an MIT type tester for paper and board” described in JIS-P8115. A specimen of the sheet was fold at a tensile force of 500 g at a folding speed of 175 frequencies per minute at a folding angle of 75 degrees. The machine direction of the sheet is taken as lengthwise direction, and the direction vertical to the machine direction is taken as crosswise direction.

The durability of a container was measured as follows. A plastic sheet was subjected to vacuum forming into a shape of a carrier tray for parts. Parts were contained in the tray and a transfer test was conducted. The state of the container after the transfer test was visually observed. Among 100 containers, the number of container(s) in which a crack or cutout was observed was determined.

### EXAMPLE 41

As a material for base material, a dispersed polystyrene resin (trade name: CLEAPACT TI300; manufactured by Dainippon Ink & Chemicals Incorporated) was provided. As a material for conductive layer, a resin composition comprising 100 parts by mass of a dispersed polystyrene resin (trade name: CLEAPACT TI350; manufactured by Dainippon Ink & Chemicals Incorporated) and 30 parts by mass of a polyether ester amide (trade name: PELESTAT NC7530; manufactured by Sanyo Chemical Industries, Ltd.) was provided.

The material for base material and the material for conductive layer were placed into a multi-T-die of a co-rotating twin-screw extruder. An anti-static sheet having a three-layer structure of conductive layer/base material/conductive layer and having a thickness of 400 μm is formed by co-extrusion. The thickness ratio of the conductive layer:base material:conductive layer is 50 μm:300 μm:50 μm. The results of measurements with respect to the anti-static sheet in Example 41 are shown in Table 10.

### EXAMPLE 42

The material for the conductive layer was changed to a resin composition comprising 100 parts by mass of a dispersed polystyrene resin (trade name: CLEAPACT TI350; manufactured by Dainippon Ink & Chemicals Incorporated) and 15 parts by mass of a polyether ester amide (trade name: PELESTAT NC7530; manufactured by Sanyo Chemical Industries, Ltd.). The procedures of Example 41 were repeated analogously with the exception described above, to form an anti-static sheet. The results of measurements with respect to the anti-static sheet in Example 42 are shown in Table 10.

### EXAMPLE 43

The material for conductive layer was changed to a resin composition comprising 100 parts by mass of a dispersed polystyrene resin (trade name: CLEAPACT TI350; manufactured by Dainippon Ink & Chemicals Incorporated) and 75 parts by mass of a polyether ester amide (trade name: PELESTAT NC7530; manufactured by Sanyo Chemical Industries, Ltd.). The procedures of Example 41 were repeated analogously with the exception described above, to form an anti-static sheet. The results of measurements with respect to the anti-static sheet in Example 43 are shown in Table 10.

### EXAMPLE 44

The material for base material was changed to a non-dispersed polystyrene resin (trade name: DENKA TX POLYMER TX100-300L; manufactured by Denki Kagaku Kogyo Kabushiki Kaisha). The procedures of Example 41 were repeated analogously with the exception described above, to form an anti-static sheet. The results of measurements with respect to the anti-static sheet in Example 44 are shown in Table 10.

### EXAMPLE 45

The material for base material was changed to a resin composition obtained by adding to 95% by weight of a non-dispersed polystyrene resin (trade name: DENKA TX POLYMER TX100-300L; manufactured by Denki Kagaku Kogyo Kabushiki Kaisha) 5% by weight of an SBR (trade name: Tufprene 126; manufactured by Asahi Kasei Corporation). The procedures of Example 41 were repeated analogously with the exception described above, to form an anti-static sheet. The results of measurements with respect to the anti-static sheet in Example 45 are shown in Table 10.

### EXAMPLE 46

The material for the base material was changed to an ABS resin (trade name: Toyolac Type 900; manufactured by Toray Industries Inc.). The procedures of Example 41 were repeated analogously with the exception described above, to form an anti-static sheet. The results of measurements with respect to the anti-static sheet in Example 46 are shown in Table 10.

### COMPARATIVE EXAMPLE 41

The material for the conductive layer was changed to a resin composition comprising 100 parts by mass of a dispersed polystyrene resin (trade name: CLEAPACT TI350; manufactured by Dainippon Ink & Chemicals Incorporated) and 30 parts by mass of a polyether ester amide (trade name: PELESTAT NC6321; manufactured by Sanyo Chemical Industries, Ltd.) having a refractive index of 1.51. The procedures of Example 31 were repeated analogously with the exception described above, to form an anti-static sheet. In the resin composition, the difference in refractive index between the polystyrene resin and the polyether ester amide is 0.03. The anti-static sheet in Comparative Example 41 has poor transparency such that the total luminous transmittance is 30% and the haze is 80. When an object was placed in a container formed from this anti-static sheet, the object could not be confirmed by an optical sensor from the outside of the container.

### COMPARATIVE EXAMPLE 42

The material for conductive layer was changed to a resin composition comprising 100 parts by mass of a dispersed polystyrene resin (trade name: CLEAPACT TI350; manufactured by Dainippon Ink & Chemicals Incorporated) and 10 parts by mass of a polyether ester amide (trade name: PELESTAT NC7530; manufactured by Sanyo Chemical Industries, Ltd.). The procedures of Example 41 were repeated analogously with the exception described above, to form an anti-static sheet. The anti-static sheet in Comparative Example 42 had a poor electrical conductivity such that the surface resistivity was 6×10¹³ Ω, and thus could not be used in packaging for IC products.

### COMPARATIVE EXAMPLE 43

It was attempted to form a sheet from, as a material for conductive layer, a resin composition comprising 100 parts by mass of a dispersed polystyrene resin (trade name: CLEAPACT TI350; manufactured by Dainippon Ink & Chemicals Incorporated) and 85 parts by mass of a polyether ester amide (trade name: PELESTAT NC7530; manufactured by Sanyo Chemical Industries, Ltd.). However, a conductive layer could not be formed into a sheet and thus an anti-static sheet could not be prepared.

TABLE 10

| | | Polyether ester | | | | Difference | Transparency | | | |
|---|---|---|---|---|---|---|---|---|---|---|
| | Surface | amide | | Polystyrene resin | | in | Total | | Folding | |
| | resistivity | Refractive | Parts | Refractive | Parts | refractive | luminous | | endurance | Container |
| | (Ω) | index | by mass | index | by mass | index | transmittance | Haze | (frequency) | durability |
| Example 41 | 8 × 10¹⁰ | 1.53 | 30 | 1.54 | 100 | 0.01 | 89 | 40 | 5500 | 0 |
| Example 42 | 3 × 10¹¹ | 1.53 | 15 | 1.54 | 100 | 0.01 | 88 | 38 | 6000 | 0 |
| Example 43 | 3 × 10⁹ | 1.53 | 75 | 1.54 | 100 | 0.01 | 87 | 42 | 4000 | 0 |
| Example 44 | 4 × 10¹⁰ | 1.53 | 30 | 1.54 | 100 | 0.01 | 88 | 40 | 800 | 25 |
| Example 45 | 4 × 10¹⁰ | 1.53 | 30 | 1.54 | 100 | 0.01 | 85 | 45 | 3000 | 1 |
| Example 46 | 6 × 10⁹ | 1.53 | 70 | 1.53 | 100 | 0.00 | 89 | 25 | 4500 | 0 |

As shown in Table 10, the sheets in Examples 41 to 46 have excellent transparency and durability. In addition, the anti-static sheets having a folding endurance of 3000 times or more in Examples 41 to 43, 45, and 46 exhibit extremely excellent container durability.

The anti-static sheet of the present invention can be processed into a tray or container by vacuum forming. The tray or container formed from the anti-static sheet of the present invention has excellent anti-static properties, and therefore it can prevent electronic parts from suffering damage due to static electricity or damage due to discharge between IC terminals. In other words, the tray or container formed from the anti-static sheet of the present is suitable for storage and transfer of electronic parts and electronic materials for ICs, LSIs, silicon wafers, hard disks, and liquid crystal substrates. In addition, the anti-static sheet has anti-static properties, and thus it can prevent generation of static electricity during mounting of electronic parts. Further, the container has transparency and therefore the electronic parts contained in the container can be confirmed by an optical sensor from the outside of the container.

Next, the fifth embodiment of the present invention will be described. In the present embodiment, explanation is made mainly on the points different from the forth embodiment, and the explanation on the same matters is omitted in order to avoid overlaps.

In the present embodiment, the constituents of the anti-static sheet are adjusted so that the sheet generates 100 ppm or less of a volatile component when subjected to heat treatment at 85° C. for 60 minutes. The volatile component corresponds to methyl methacrylate (MMA), toluene, ethylbenzene, styrene, methylethylbenzene, benzaldehyde, caprolactam, and butylhydroxytoluene (BHT).

For reducing the volatile component content, the following methods (1) to (3) are employed. These methods (1) to (3) may be employed in combination.

(1) As the polystyrene resin, one having a low volatile component content is selected. Commercially available polystyrene resins generally have a volatile component content of 200 to 500 ppm. Therefore, in the step of re-pelletization of the polystyrene resin, the pellets are degassed in a molten form at a vacuum pressure of 5 Torrs or less at a temperature which is higher than the glass transition temperature (Tg) of a polystyrene resin by 50° C. or more. Thus, pellets having a volatile component content of 100 ppm or less are produced.

(2) When the polystyrene resin and the polyether ester amide are melted and kneaded and shaped into a sheet, they are degassed in a molten form at a vacuum pressure of 5 Torrs or less at a temperature higher than the glass transition temperature (Tg) of a polystyrene resin by 50° C. or more. Thus, a sheet having a volatile component content of 100 ppm or less was obtained. When the volatile component content cannot be reduced to 100 ppm or less by one degassing operation, the resin mixture may be degassed in several portions, that is, subjected to so-called multi-stage vacuum degassing.

(3) The polystyrene resin and the polyether ester amide were melted and kneaded, and shaped into a sheet, and the sheet was annealed as a post-treatment. Specifically, the sheet was annealed at the glass transition temperature (Tg) of a polystyrene resin or higher. Thus, a sheet having a volatile component content of 100 ppm or less was obtained.

The anti-static sheet of the present embodiment has excellent vacuum formability. The anti-static sheet can be processed into a tray or container by vacuum forming. The tray or container formed from the anti-static sheet of the present embodiment has anti-static properties, and therefore it can prevent a damage due to electrostatic discharge, and is suitable for storage and transfer of electronic parts and electronic materials for ICs, LSIs, silicon wafers, hard disks, and liquid crystal substrates. In addition, the anti-static sheet of the present invention has anti-static properties, and thus it can prevent generation of static electricity during mounting of electronic parts to a container.

(Examples)

Hereinbelow, the present embodiment will be described in more detail with reference to the following Examples. With respect to each of the specimens in the Examples, a surface resistivity, a total luminous transmittance, a haze, and a volatile component content were measured. The volatile component content was determined by measurement of total ion chromatography (TIC) using head space gas chromatography (HS-GC-MS) with respect to the gas obtained after heat treatment at 85° C. for 60 minutes. In this case, the quantitative determination of the volatile component content was made in terms of toluene.

### EXAMPLE 51

100 Parts by mass of a dispersed polystyrene resin (trade name: CLEAPACT TI300; manufactured by Dainippon Ink & Chemicals Incorporated) and 40 parts by mass of a polyether ester amide (trade name: PELESTAT NC7530; manufactured by Sanyo Chemical Industries, Ltd.) were individually placed into a co-rotating twin-screw extruder and melted together. Then, the resultant mixture was subjected to extrusion using a T-die to obtain an anti-static sheet having a thickness of 700 μm. In the melting and kneading using the extruder, a vacuum state at 3 Torrs at 200° C. was created by suction through two points. The results of measurements with respect to the anti-static sheet in Example 51 are shown in Table 11.

### EXAMPLE 52

100 Parts by mass of a dispersed polystyrene resin (trade name: CLEAPACT TI300; manufactured by Dainippon Ink & Chemicals Incorporated) and 40 parts by mass of a polyether ester amide (trade name: PELESTAT NC7530; manufactured by Sanyo Chemical Industries, Ltd.) were individually placed into a co-rotating twin-screw extruder and mixed together. Then, the resultant mixture was melted and kneaded so as to effect re-pelletization to form pellets. In the re-pelletization, a vacuum state at 3 Torrs was created in the twin-screw extruder by suction through two points. The pellets obtained by the re-pelletization were placed into a single-screw extruder and extruded through a T-die. As the result, an anti-static sheet having a thickness of 700 μm was obtained. The results of measurements with respect to the anti-static sheet in Example 52 are shown in Table 11.

### EXAMPLE 53

100 Parts by mass of a dispersed polystyrene resin (trade name: CLEAPACT TI300; manufactured by Dainippon Ink & Chemicals Incorporated) and 40 parts by mass of a polyether ester amide (trade name: PELESTAT NC7530; manufactured by Sanyo Chemical Industries, Ltd.) were placed into a single-screw extruder and extruded through a T-die to obtain an anti-static sheet having a thickness of 700 μm. The obtained anti-static sheet was annealed at 85° C. for 5 hours. The results of measurements with respect to the anti-static sheet in Example 53 are shown in Table 11.

### EXAMPLE 54

The proportion of the dispersed polystyrene resin and polyether ester amide of Example 51 was changed to 15 parts by mass of polyether ester amide relative to 100 parts by mass of the dispersed polystyrene resin. With the exception described above, an anti-static sheet having a thickness of 700 μm was obtained in the same manner as in Example 51. The results of measurements with respect to the anti-static sheet in Example 54 are shown in Table 11.

### EXAMPLE 55

The proportion of the dispersed polystyrene resin and polyether ester amide was changed to 75 parts by mass of polyether ester amide relative to 100 parts by mass of dispersed polystyrene. With the exception described above, an anti-static sheet having a thickness of 700 μm was obtained in the same manner as in Example 51. The results of measurements with respect to the anti-static sheet in Example 55 are shown in Table 11.

### COMPARATIVE EXAMPLE 51

An anti-static sheet having a thickness of 700 μm was obtained in the same manner as in Example 53 except that the extruded sheet was not annealed. The results of measurements with respect to the anti-static sheet in Comparative Example 51 are shown in Table 11.

### COMPARATIVE EXAMPLE 52

The proportion of the dispersed polystyrene resin and polyether ester amide was changed to 10 parts by mass of polyether ester amide relative to 100 parts by mass of the polystyrene resin. With the exception described above, an anti-static sheet having a thickness of 700 μm was obtained in the same manner as in Example 51. The results of measurements with respect to the anti-static sheet in Comparative Example 52 are shown in Table 11.

### COMPARATIVE EXAMPLE 53

The proportion of the dispersed polystyrene resin and polyether ester amide was changed to 80 parts by mass of polyether ester amide relative to 100 parts by mass of the dispersed polystyrene. With exception described above, it was attempted to form an anti-static sheet having a thickness of 700 μm in the same manner as in Example 51. However, the anti-static sheet in Comparative Example 53 became a rubber-like sheet, and could not be used as a sheet for shaping. The results of measurements with respect to the anti-static sheet in Comparative Example 53 are shown in Table 11.

TABLE 11

| | | | Polyether ester | | Difference | | | | |
|---|---|---|---|---|---|---|---|---|---|
| | Polystyrene resin | | amide | | in | Transparency | | Surface | Volatile |
| | Refractive | Parts | Refractive | Parts | refractive | Total luminous | | resistivity | component |
| | index | by mass | index | by mass | index | transmittance | Haze | (Ω) | (ppm) |
| Example 51 | 1.54 | 100 | 1.53 | 40 | 0.01 | 89 | 45 | 2 × 10¹¹ | 45 |
| | | | | | | ◯ | ◯ | ◯ | ◯ |
| Example 52 | 1.54 | 100 | 1.53 | 40 | 0.01 | 90 | 38 | 1 × 10¹¹ | 55 |
| | | | | | | ◯ | ◯ | ◯ | ◯ |
| Example 53 | 1.54 | 100 | 1.53 | 40 | 0.01 | 87 | 49 | 2 × 10¹¹ | 70 |
| | | | | | | ◯ | ◯ | ◯ | ◯ |
| Example 54 | 1.54 | 100 | 1.53 | 15 | 0.01 | 89 | 41 | 8 × 10¹¹ | 40 |
| | | | | | | ◯ | ◯ | ◯ | ◯ |
| Example 55 | 1.54 | 100 | 1.53 | 75 | 0.01 | 90 | 40 | 1 × 10¹¹ | 65 |
| | | | | | | ◯ | ◯ | ◯ | ◯ |
| Comparative | 1.54 | 100 | 1.53 | 40 | 0.01 | 80 | 48 | 6 × 10¹¹ | 450 |
| example 51 | | | | | | X | ◯ | ◯ | X |
| Comparative | 1.54 | 100 | 1.53 | 10 | 0.01 | 89 | 42 | 2 × 10¹³ | 30 |
| example 52 | | | | | | ◯ | ◯ | X | ◯ |
| Comparative | 1.54 | 100 | 1.53 | 80 | 0.01 | 79 | 56 | 3 × 10¹⁰ | 110 |
| example 53 | | | | | | X | X | ◯ | X |

As shown in Table 11, the anti-static sheets in Examples 51 to 55 have good anti-static properties such that the surface resistivity is in the range of from 10⁹ to 10¹² Ω. Therefore, they can keep insulation between an electronic circuit board and a metallic housing or between IC terminals. Further, the sheets in Examples 51 to 55 have excellent transparency and durability. In addition, the anti-static sheets obtained in Examples 51 to 55 had a volatile component content of 100 ppm or less.

By contrast, the anti-static sheets in Comparative Examples 51 and 53 have poor transparency and have a volatile component content of more than 100 ppm. Therefore, the anti-static sheets in Comparative Examples 51 and 53 cause electronic parts to suffer contamination. The sheet in Comparative Example 52 has a surface resistivity of 2×10¹³. This sheet has a problem about the anti-static properties and thus cannot be used in packaging for electronic parts.

The anti-static sheet of the present embodiment not only has the above-mentioned effects of the fourth embodiment but also can prevent electronic parts from suffering contamination due to the volatile component. Therefore, the present invention can be applied to precision electronic parts which must be prevented from suffering adhesion of contaminant.

Next, the sixth embodiment of the present invention will be described. In the present embodiment, explanation is made mainly on the points different from the forth embodiment, and the explanation on the same matters is omitted in order to avoid overlaps.

The anti-static sheet is comprised mainly of a resin composition comprising 15 to 75 parts by mass of a polyether ester amide as a conductive agent relative to 100 parts by mass of a dispersed polystyrene resin, wherein the difference in refractive index between the polystyrene resin and the polyether ester amide is less than 0.03, and 1 to 10 parts by mass of a graft polymer comprising epoxy-modified acryl, polystyrene, and polymethyl methacrylate (PMMA).

When the anti-static sheet has a surface resistivity of 10⁹ to 10¹² Ω, insulation between an electronic circuit board and a metallic housing can be kept. The surface resistivity is indicated by a value as measured in accordance with JIS-K6911 by means of an ultra insulation meter at a temperature of 23° C. and at a humidity of 50%.

When the amount of the polyether ester amide is less than 15 parts by mass, a desired surface resistivity cannot be obtained. On the other hand, when the amount of the polyether ester amide is more than 75 parts by mass, the resultant sheet becomes a rubber-like sheet and therefore cannot be used as a sheet for shaping.

The graft polymer comprising epoxy-modified acryl, polystyrene, and polymethyl methacrylate (PMMA) preferably used in the present embodiment is obtained by copolymerizing a high molecular-weight monomer or polymer and a low molecular-weight monomer having a polymerizable functional group at one terminal. Reactive functional groups are introduced into the copolymer at a backbone and a superstrate. As a monomer or polymer forming the backbone, polystyrene or PMMA is used. As a monomer forming the superstrate, epoxy-modified acryl or styrene is used. The graft polymer can increase the compatibility at the interface between the polystyrene resin and the polyether ester amide.

The amount of the graft polymer is 1 to 10 parts by mass, relative to 100 parts by mass of the polystyrene resin. When the amount added of the graft polymer is 3 to 8 parts by mass, the physical properties of the sheet can be improved while maintaining transparency of the sheet. When the amount of the graft polymer is less than 1 part by mass, the hydro shot impact value cannot be improved in a desired range. When the amount of the graft polymer is more than 10 parts by mass, the transparency of the resultant sheet becomes poor.

The anti-static sheet is obtained by, for example, individually feeding a transparent polystyrene resin, a polyether ester amide, and a graft polymer into a twin-screw extruder, melting, kneading, and degassing the resultant mixture, and extruding the mixture through a T-die into a sheet form. Alternatively, a resin composition comprised mainly of a polystyrene resin, a polyether ester amide, and a graft polymer may be preliminarily formed, and fed to an extruder and extruded through a T-die into a sheet form.

It is desired that the anti-static sheet generally has a thickness in the range of from 0.2 to 2.0 mm.

(Examples)

Hereinbelow, the present embodiment will be described in more detail with reference to the following Examples. With respect to each of the specimens in the Examples, a surface resistivity, a total luminous transmittance, a haze, a hydro shot impact value, and container durability are measured. The methods for measurements and evaluations for the surface resistivity, total luminous transmittance, haze, and container durability are the same as those used in the above embodiments.

The hydro shot impact value is determined in accordance with JIS K7124-2. Rating ◯ indicates that a specimen has a hydro shot impact value of 250 kgf·mm or more, and rating χ indicates that a specimen has a hydro shot impact value of less than 250 kgf·mm. The criteria for the evaluation of the container durability are as follows. Rating ◯ indicates that no crack or cutout was caused in a container, and rating χ indicates that one or more cracks or cutouts were caused in a container.

### EXAMPLE 61

100 Parts by mass of a dispersed polystyrene resin (trade name: CLEAPACT TI300; manufactured by Dainippon Ink & Chemicals Incorporated), 40 parts by mass of a polyether ester amide (trade name: PELESTAT NC7530; manufactured by Sanyo Chemical Industries, Ltd.), and 7 parts by mass of a graft polymer (trade name: RESEDA GP301; manufactured by Toagosei Co., Ltd.) having a backbone of PMMA and a superstrate of epoxy-modified acryl are individually placed into a co-rotating twin-screw extruder. The resultant mixture is fed to a T-die while being melted and kneaded, followed by extrusion using the T-die, to obtain an anti-static sheet having a thickness of 700 μm. The results of measurements with respect to the anti-static sheet in Example 61 are shown in Table 12.

### EXAMPLE 62

The amount of the polyether ester amide added was changed to 15 parts by mass and the amount of the graft polymer added was changed to 1 part by mass. With the exception described above, an anti-static sheet was obtained in the same manner as in Example 61. The results of measurements with respect to the anti-static sheet in Example 62 are shown in Table 12.

### EXAMPLE 63

The amount of the polyether ester amide added was changed to 75 parts by mass and the amount of the graft polymer added was changed to 10 part by mass. With the exception described above, an anti-static sheet was obtained in the same manner as in Example 61. The results of measurements with respect to the anti-static sheet in Example 63 are shown in Table 12.

### COMPARATIVE EXAMPLE 61

An anti-static sheet was obtained in the same manner as in Example 61 except that no graft polymer was added. The results of measurements with respect to the anti-static sheet in Comparative Example 61 are shown in Table 12.

### COMPARATIVE EXAMPLE 62

The amount of the polyether ester amide added was changed to 10 parts by mass. With the exception described above, an anti-static sheet was obtained in the same manner as in Example 61. The results of measurements with respect to the anti-static sheet in Comparative Example 62 are shown in Table 12.

### COMPARATIVE EXAMPLE 63

The amount of the polyether ester amide added was changed to 80 parts by mass. With the exception described above, an anti-static sheet was obtained in the same manner as in Example 61. The results of measurements with respect to the anti-static sheet in Comparative Example 63 are shown in Table 12.

### COMPARATIVE EXAMPLE 64

The amount of the graft polymer added was changed to 0.5 part by mass. With the exception described above, an anti-static sheet was obtained in the same manner as in Example 61. The results of measurements with respect to the anti-static sheet in Comparative Example 64 are shown in Table 12.

### COMPARATIVE EXAMPLE 65

The amount of the graft polymer added was changed to 12 part by mass. With the exception described above, an anti-static sheet was obtained in the same manner as in Example 61. The results of measurements with respect to the anti-static sheet in Comparative Example 65 are shown in Table 12.

TABLE 12

| | Polystyrene | | Polyether ester | | Graft | Hydro shot | Transparency | | | |
|---|---|---|---|---|---|---|---|---|---|---|
| | resin | | amide | | polymer | impact | Total | | Surface | Container |
| | Refractive | Parts | Refractive | Parts | [part(s) | value | luminous | | resistivity | durability |
| | index | by mass | index | by mass | by mass] | (kgf · mm) | transmittance | Haze | (Ω) | (piece) |
| Example 61 | 1.54 | 100 | 1.53 | 40 | 7 | 680 | 89 | 45 | 2 × 10¹¹ | 0 |
| | | | | | | ◯ | ◯ | ◯ | ◯ | ◯ |
| Example 62 | 1.54 | 100 | 1.53 | 15 | 1 | 250 | 90 | 38 | 1 × 10¹¹ | 0 |
| | | | | | | ◯ | ◯ | ◯ | ◯ | ◯ |
| Example 63 | 1.54 | 100 | 1.53 | 75 | 10 | 910 | 87 | 49 | 6 × 10¹⁰ | 0 |
| | | | | | | ◯ | ◯ | ◯ | ◯ | ◯ |
| Comparative | 1.54 | 100 | 1.53 | 40 | 0 | 85 | 89 | 41 | 2 × 10¹¹ | 34 |
| example 61 | | | | | | X | ◯ | ◯ | ◯ | X |
| Comparative | 1.54 | 100 | 1.53 | 10 | 7 | 470 | 90 | 40 | 3 × 10¹³ | 0 |
| example 62 | | | | | | ◯ | ◯ | ◯ | ◯ | ◯ |
| Comparative | 1.54 | 100 | 1.53 | 80 | 7 | 840 | 80 | 62 | 6 × 10¹⁰ | 0 |
| example 63 | | | | | | ◯ | X | X | ◯ | X |
| Comparative | 1.54 | 100 | 1.53 | 40 | 0.5 | 160 | 89 | 42 | 2 × 10¹¹ | 26 |
| example 64 | | | | | | X | ◯ | ◯ | X | X |
| Comparative | 1.54 | 100 | 1.53 | 40 | 12 | 870 | 79 | 56 | 3 × 10¹¹ | 0 |
| example 65 | | | | | | ◯ | X | X | ◯ | ◯ |

The present embodiment has not only the above-mentioned effects of the forth and fifth embodiments but also the following effects. Specifically, as shown in Table 12, the sheets in Examples 61 to 63 have good anti-static properties such that the surface resistivity is in the range of from 10⁹ to 10¹² Ω. Therefore, they can keep insulation between an electronic circuit board and a metallic housing or between IC terminals. Further, the sheets in Examples 61 to 63 have excellent transparency. The anti-static sheets in Examples 61 to 63 have a large hydro shot impact value, and products obtained by shaping these sheets have excellent durability such that no crack or cutout is caused.

By contrast, the anti-static sheets in Comparative Examples 61 and 64 have a small hydro shot impact value. Products obtained by shaping these sheets had poor durability. The sheet in Comparative Example 62 had a surface resistivity of 3×10¹³ and had a problem about the anti-static properties. Therefore, the sheet in Comparative Example 62 could not be used in packaging for electronic parts. The sheets in Comparative Examples 63 and 65 had poor transparency, and therefore the electronic parts contained in containers formed from these sheets could not be confirmed by an optical sensor from the outside of the containers. In addition, the sheet in Comparative Example 63 became a rubber-like sheet,. and thus could not be used as a sheet for shaping.

The embodiments are not limited to those mentioned above, and, for example, may be implemented as follows.

In the second embodiment, a sheet (film) as the core layer 2 and sheets (films) as the outer layers 3 may be separately produced, and then stacked on one another to form the anti-static sheet 1.

In the third embodiment, when an opaque thermoplastic resin is used as a material for the outer layer 13, a polyether ester amide may be used as a conductive filler.

In the third embodiment, a lubricant and a processing aid used in general plastic processing may be added to the thermoplastic resin constituting the core layer 12 or the outer layer 13. When a polystyrene resin having no rubber-like elastomer dispersed therein is used, it is preferred to adjust the melt viscosity of the composition by this method. Further, if desired, a stabilizer, a plasticizer, and a coloring agent may be added.

In the third embodiment, when the molten resin for the core layer and the molten resin for the outer layer are mixed together using a feed block, the resin for the core layer is first extruded into a quadratic prism shape, and then the molten resin for the outer layer may be mixed with the resin for the core layer so that the resin for the outer layer covers the extruded product in a quadratic prism shape.

In the third embodiment, as the conductive filler for the core layer 12, a filler other than carbon black and the polyether ester amide may be used.

In the third embodiment, a sheet having many pores formed therein is first formed as the core layer 12, and then both surface of the sheet may be coated with a molten resin as the outer layer 13 to form the anti-static sheet 11. For example, using an extrusion lamination machine, a sheet for the core layer 12 is used as the base material and coated with a thermoplastic resin as the outer layer 13.

1. (Cancel)

2. (Cancel)

3. (Cancel)

4. (Unchanged) a resin composition comprising:
60 to 85% by weight of a polystyrene resin, wherein said polystyrene resin is a copolymer comprising a styrene monomer and a (meth)acrylate monomer; and
15 to 40% by weight of a polyether ester amide,
being characterized in that said resin composition has a melt viscosity of 2×10³ to 8×10⁴ (poises) at a shear rate of 10 (sec⁻¹) at 200° C.

5. (Unchanged) A resin composition comprising:
60 to 85% by weight of a polystyrene resin, wherein said polystyrene resin is a copolymer comprising a styrene monomer and a (meth)acrylate monomer, which has a rubber-like elastomer dispersed therein; and
15 to 40% by weight of a polyether ester amide,
wherein said resin composition has a melt viscosity of 2×10³ to 8×10⁴ (poises) at a shear rate of 10 (sec⁻¹) at 200° C.

6. The resin composition according to claims 4 or 5, characterized in that said polystyrene resin has transparency, and wherein the difference in refractive index between said polystyrene resin and said polyether ester amide is 0.03 or less.

7. (Unchanged) An extruded article which is produced from, as a shaping material, the resin composition according to any one of claims 4 to 6.

8. (Unchanged) An anti-static sheet comprising:
a core layer (2), formed by dispersing a polyether ester amide in a thermoplastic resin, having an elastic modulus in tension of 900 MPa or more at ordinary temperature and having a volume resistivity of 10¹² Ω·cm or less; and
an outer layer (3) formed, on the surface of said core layer (2), from a material obtained by dispersing a polyether ester amide in a thermoplastic resin so that said outer layer (3) has a surface resistivity of 10¹⁰ Ω or less.

9. (Unchanged) The anti-static sheet according to claim 8, characterized in that each of said core layer (2) and said outer layer (3) is formed by co-extrusion.

10. (Unchanged) The anti-static sheet according to claims 8 or 9, characterized in that each of said polyether ester amide and said thermoplastic resin has transparency, and wherein the difference in refractive index between said polyether ester amide and said thermoplastic resin is 0.03 or less.

11. (Unchanged) The anti-static sheet according to claim 10, characterized in that said thermoplastic resin is a copolymer comprising a styrene monomer and a (meth)acrylate monomer.

12. (Unchanged) An anti-static sheet comprising:
a plurality of core layers (12) each comprising a thermoplastic resin; and
an outer layer (13) comprising a thermoplastic resin containing therein an electrically conductive filler, characterized in that said outer layer (13) is formed so that said core layers (12) are disposed between said outer layer (13), and has a connection portion (13c) for connecting the adjacent core layers (12).

13. (Unchanged) The anti-static sheet according to claim 12, characterized in that each of said core layer (12) and said outer layer (13) is formed by co-extrusion.

14. (Unchanged) The anti-static sheet according to claims 12 or 13, characterized in that said thermoplastic resin used in said core layers (12) is a polystyrene resin or an ABS resin, and wherein said resin used in said outer layer (13) is a polystyrene resin or ABS resin containing therein carbon black.

15. (Unchanged) The anti-static sheet according to claim 14, characterized in that said polystyrene resin is a polystyrene resin having impact resistance.

16. (Unchanged) The anti-static sheet according to claims 12 or 13, characterized in that said thermoplastic resin used in said core layers (12) is a polystyrene resin or an ABS resin, and wherein said resin used in said outer layer (13) is a polystyrene resin or ABS resin containing therein a polyether ester amide.

17. (Unchanged) The anti-static sheet according to claim 16, characterized in that said thermoplastic resin is a copolymer comprising a styrene monomer and a (meth)acrylate monomer.

18. (Unchanged) An anti-static sheet comprising:
a sheet base material comprising a polystyrene or ABS resin; and
a layer formed on at least one surface of said sheet base material, said layer comprising 15 to 75 parts by mass of a polyether ester amide relative to 100 parts by mass of a polystyrene resin, wherein the difference in refractive index between said polystyrene resin and said polyether ester amide is less than 0.03,
wherein said layer has a surface resistivity of 10⁹ to 10¹² Ω.

19. (Unchanged) The anti-static sheet according to claim 18, being characterized by having a folding endurance of 3000 times or more as measured in accordance with the MIT test described in JIS-P-8115.

20. (Unchanged) An anti-static sheet being characterized by:
15 to 75 parts by mass of a polyether ester amide relative to 100 parts by mass of a polystyrene resin;
wherein the difference in refractive index between said polystyrene resin and said polyether ester amide is less than 0.03,
wherein said anti-static sheet is subjected to heat treatment at 85° C. for 60 minutes to generate 100 ppm or less of a volatile component.

21. (Unchanged) An anti-static sheet being characterized by:
100 parts by mass of a polystyrene resin;
15 to 75 parts by mass of a polyether ester amide, wherein the difference in refractive index between said polystyrene resin and said polyether ester amide is less than 0.03; and
1 to 10 parts by mass of a graft polymer comprising epoxy-modified acryl, polystyrene, and polymethyl methacrylate (PMMA).
